(19) United States
(12) Patent Application Publication
(10) Pub. No.: US 2006/0224422 A1
(43) Pub. Date: Oct. 5, 2006

(54) System and method for applying for insurance at a point of sale

(76) Inventor: Ralph B. Cohen, Northbrook, IL (US)

Correspondence Address: MCANDREWS HELD & MALLOY, LTD, 500 WEST MADISON STREET, SUITE 3400, CHICAGO, IL, 60661, US

(21) Appl. No.: 11/361,932

(22) Filed: Feb. 24, 2006

Related U.S. Application Data
(60) Provisional application No. 60/656,266, filed on Feb. 25, 2005.

(51) Int. Cl. G06Q 40/00

(52) U.S. Cl. 705/4

(57) ABSTRACT

A method for applying for insurance for a product at a point of sale is described. The method comprises obtaining an appraisal for a product at a point of sale; a customer, in response to receiving the appraisal for the product at a point of sale, compensating the point of sale; completing an insurance application at the point of sale; submitting, from the point of sale, the appraisal and the insurance application to an insurance intermediary; and the insurance intermediary, in response to receiving the appraisal and the insurance application, selecting an insurance provider and submitting the appraisal and the insurance application to the insurance provider.

### CROSS-REFERENCE TO RELATED PATENT APPLICATIONS

This application cross-references U.S. patent application “Method and System for Formation of an Electronically Definable Catalog,” patent application Ser. No. 09/841,876, filed on Apr. 24, 2001, listing Ralph B. Cohen as the first-named inventor, now abandoned, which is incorporated herein in its entirety. This application claims priority to U.S. provisional patent application entitled “Method for Applying for Insurance at a Point of Sale”, provisional patent application No. 60/656,266, filed on Feb. 25, 2005, listing Ralph B. Cohen as the first-named and sole inventor, which is incorporated herein in its entirety.

### FIELD OF THE INVENTION

This invention pertains to methods and systems for applying for insurance at a point of sale. More particularly, this invention pertains to methods and systems for applying for jewelry, fine art, antique, collectables or coin insurance, or insurance for any product that might have an insurable value, at a point of sale.

This invention also pertains to a method and system for formation of an electronically definable catalog. More particularly, this invention pertains to a method and system for formation of an HTML electronically definable catalog.

### BACKGROUND OF THE INVENTION

Currently, customers who purchase jewelry must independently obtain an appraisal, identify an insurance provider and apply for jewelry insurance after leaving a point of sale. This process can be inconvenient to the customer and subject the customer to the risks of destruction, theft or damage of the jewelry during the period when the jewelry is not insured. Thus, there is a need for a method of applying for jewelry insurance at a point of sale.

An appraisal of an article of jewelry is generally required in order to make an application for jewelry insurance on the article of jewelry. Additionally, presenting an appraisal to an insurance provider in a clear format that is uniform across all appraisals performed by an appraiser can enable an insurance provider to efficiently evaluate an application for insurance and to efficiently ensure the replacement of destroyed, stolen or lost jewelry. Thus, there is a need for a method of providing a consistent and uniform appraisal format to an insurance provider.

Clear and uniform appraisals can be generated using software programs. Unlike appraisal generated with the human hand, appraisals prepared by an appraiser with the aid of software programs are more likely to be generated in a consistently uniform fashion. Additionally, the incorporation of a picture in the appraisal can make the appraisal more precise as to the jewelry product being evaluated. The replacement, repair, or payment for a lost or damaged jewelry product can become more efficient when there is a visual component to an appraisal. As such, there is a need for software which can generate clear and uniform pictorial appraisals.

Software programs can also be useful to jewelers at a point of sale in performing other customer-, sales-, and inventory-related tasks. For example, standard paper catalogs or advertising materials are typically created and printed for mass distribution or mass mailing to potential customers. Because of the costs and time involved in laboriously preparing such catalogs or advertising materials, standard catalogs and marketing materials are generally aimed at wide demographic groups, rather than tailored to meet the needs of specific demographic subgroups or customers. For example, the contents of standard catalogs may include an entire assortment of products offered by a supplier or store, some of which may be irrelevant to certain customers. Although standard catalogs and advertising materials cost less if printed and distributed in bulk, the store or supplier may be missing out on sales opportunities because of the inadequate targeting of customers. For instance, the sheer volume of the products and goods offered in some catalogs or advertising materials may discourage customers from the bother of fully viewing the catalog or may inhibit customers from finding a desired item. The catalog or advertising materials may arrive at a customer's residence or premises at an inconvenient time when the customer is not seeking the goods or services offered. The customer may disregard or dispose of the catalog only to later find that the catalog would have been of use in the future. At other times customers may save catalogs and be unable to retrieve them or find them because of inadequate filing methods and procedures within a home or business. Therefore targeting the interests of a customer becomes essential for an efficient marketing strategy. Thus, for example, there is a need for software which provides the ability to reduce inventory of a supplier of jewelry by sharing such inventory in a cooperative manner among one or more suppliers of jewelry, in particular. In general, there is a need for software which can be used in performing customer-, sales-, and inventory-related tasks. Further, there is a need for software which can be used in performing customer-, sales-, and inventory-related tasks that can optionally incorporate clear, high quality, images.

### SUMMARY OF THE INVENTION

In one embodiment of the present invention, a method for applying for insurance for a jewelry product at a point of sale is described. The method comprises obtaining an appraisal for a product at a point of sale; completing an insurance application at the point of sale; the point of sale, in response to obtaining an appraisal for a product at a point of sale, receiving compensation from a customer for which the appraisal was obtained; submitting, from the point of sale, the appraisal and the insurance application to an insurance intermediary; and the insurance intermediary, in response to receiving the appraisal and the insurance application, selecting an insurance provider and submitting the appraisal and the insurance application to the insurance provider. Alternatively, an appraisal may be generated without compensation.

In a second embodiment of the present invention, a method for applying for insurance for a jewelry product at a point of sale is described. The method comprises obtaining an appraisal for a product at a point of sale; completing an insurance application at the point of sale; the point of sale, in response to obtaining an appraisal for a product at a point of sale, receiving compensation from a customer for which the appraisal was obtained; submitting, from point of sale, the appraisal and the insurance application to an insurance provider and an insurance intermediary; the insurance provider, in response to receiving the appraisal and the insurance application, compensating the insurance intermediary. Alternatively, an appraisal may be generated without compensation.

In a third embodiment of the present invention, a computer program product for applying for insurance for a jewelry product at a point of sale is described.

In a fourth embodiment of the present invention, a device or applying for insurance for a jewelry product at a point of sale is described.

In a fifth embodiment of the present invention, a method for formation of an HTML electronically definable catalog is described.

In a sixth embodiment of the present invention, a system for formation of an HTML electronically definable catalog is described. In a seventh embodiment of the present invention, a method for applying for insurance for a jewelry product at a point of sale is described. The method comprises obtaining an appraisal that has been generated by an appraiser located at a location other than the point of sale, such as at the insurance intermediary location, or alternately at a central office for a group of related retail outlets, for a product at a point of sale; compensating the appraiser upon printing the appraisal at the point of sale; completing an insurance application at the point of sale; submitting, from the point of sale, the appraisal and the insurance application to an insurance intermediary; the appraiser, in response to receiving compensation for the appraisal, the appraiser compensating the software provider with some portion of the compensation received for the appraisal if the software provider's software was used by the appraiser to distribute the appraisal; the insurance intermediary, in response to receiving the appraisal and the insurance application, selecting an insurance provider and submitting the appraisal and the insurance application to the insurance provider.

The advantages of the foregoing include convenience to and security for the customer, as applying for insurance for a product at a point of sale alleviates the need for the customer to independently obtain an appraisal, identify an insurance provider and apply for jewelry insurance, and minimizes the risk of loss that is experienced during the time when a customer's jewelry is not insured. The creation and distribution of a pictorial database incorporating images, detailed descriptions and values of jewelry products for sale, that can be linked in a software program with a consumer purchasing one or more of these jewelry products and produce for the consumer an appraisal, can facilitate the purchase of insurance in the manner stated herein. These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is an illustration of an exemplary system 100 in which a method for applying for insurance for a product, including, but not limited to, jewelry products, fine art products, antiques, collectables or coins any product that might have an insurable value, at a point of sale according to an embodiment of the present invention can be performed.

FIG. 2 is an exemplary flowchart illustrating a method for applying for insurance for a jewelry product at a point of sale according to an embodiment of the present invention.

FIG. 2a is an exemplary flowchart illustrating a method for applying for insurance for a jewelry product at a point of sale according to another embodiment of the present invention.

FIG. 2b is an exemplary illustration depicting a Virtual Inventory Point of Sale user interface for generating a document containing an appraisal at a point of sale when the jewelry product is in a Virtual Inventory database that is accessible by the Virtual Inventory Point of Sale Appraisal module.

FIG. 3 is an exemplary schematic flowchart illustrating a method for applying for insurance for a jewelry product at a point of sale according to an embodiment of the present invention.

FIG. 4 is an exemplary illustration of a device that can perform a method for applying for insurance for a jewelry product at a point of sale according to an embodiment of the present invention.

FIG. 5 is a block diagram of a system for formation and distribution of an electronically definable catalog via a communications network in accordance with an embodiment of the present invention.

FIG. 6 is a flowchart of a method for formation of an electronically definable catalog in accordance with an embodiment of the present invention.

FIG. 7 is a block diagram of an inventory-sharing system that may use an electronically definable catalog for incorporation into an inventory-sharing file in accordance with an embodiment of the present invention.

FIG. 8 is a method for sharing inventory among trading partners in accordance with an embodiment of the present invention.

FIG. 9 is a data structure of an electronically definable catalog in accordance with an embodiment of the present invention.

FIG. 10 is a data structure of a viewer file that may contain the electronically definable catalog of FIG. 9 in accordance with an embodiment of the present invention.

FIG. 11 is a data structure of an inventory-sharing file in accordance with an embodiment of the present invention.

FIG. 12 shows a flowchart of a method for constructing a viewer file containing the electronically definable catalog in accordance with an embodiment of the present invention.

FIG. 13 is a flow chart of a method for extracting or reading the viewer file of FIG. 12 in accordance with an embodiment of the present invention.

FIG. 14 is a reproduction of a black-and-white photograph of the presentation of an electronically definable catalog in accordance with an embodiment of the present invention.

### DETAILED DESCRIPTION

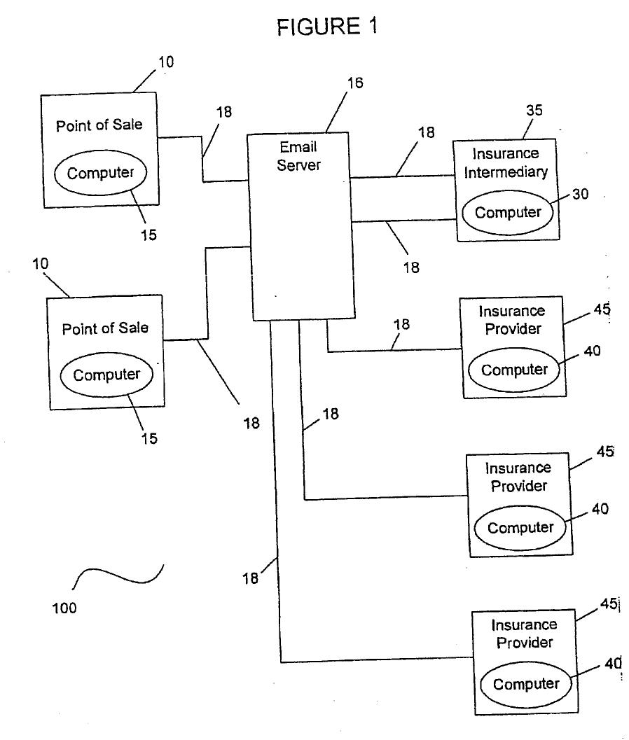

FIG. 1 is an illustration of an exemplary system 100 in which a method for applying for insurance for a product, including, but not limited to, jewelry products, fine art products, antiques, collectables or coins any product that might have an insurable value, at a point of sale according to an embodiment of the present invention can be performed. FIG. 1 will be further described with regard to a jewelry product as an exemplary case of the type of product for which the system described in FIG. 1 can be employed.

The system 100 comprises an email server 16, one or more points of sale (“POS”) 10, one or more insurance providers (“IP”) 45 and an insurance intermediary (“II”) 35. As used herein, “point of sale” means a location from which a jewelry product can be purchased. The POS need not be the actual location from which the jewelry product was purchased. As used herein, the term “insurance provider” means the organization or person that underwrites and issues the insurance policy. As used herein, the term “insurance intermediary” means the organization or person that facilitates the insurance application process by referring the customer to the insurance provider and compensating the appraiser at the renewal of any insurance policy obtained by the customer.

In the exemplary system, each POS 10 has at least one POS computer (“POS-C”) which runs software that is capable of enabling a customer to obtain an appraisal, produce an insurance application and transmit the appraisal and the completed insurance application as attachments to an email. The email is directed to an email address belonging to the II 35 or the IP 45. The POS-C can also contain functionality for the following: receiving electronic files from a scanner or other mechanical device that is capable of receiving documents in paper version and converting the documents into electronic files; faxing electronic versions of the appraisal and the completed insurance application; uploading or downloading electronic versions of the appraisal and the completed insurance application to or from a website and/or database belonging to the II 35 or the IP 45; and causing a printer to print paper versions of the appraisal and the insurance application which have been produced or retrieved on the POS-C 15. The POS-C 15 sends the email to the email server 16 and the email server 16 sends the email to the storage location corresponding to the email address belonging to the II 35 and/or the IP 45.

In the embodiment in which the appraisal and the completed insurance application are faxed, they can be faxed to a Data Center that can then forward the information to the II 35, which can then forward the information to the IP 45. In this embodiment, the II 35 can record the transmission of the appraisal and the completed insurance application using a program that can create a database that records the customer name and contact information along with appraisal value.

The II 35 and the IP 45 each have at least one associated computer, respectively II-C 30 and IP-C 40, which is capable of running software enabling the II-C 30 and the IP-C 40 to access the appraisal and the completed insurance application sent via email and to send and retrieve emails generally. The II-C 30 and the IP-C 40 can also contain functionality for the following: receiving electronic files from a scanner or other mechanical device that is capable of receiving documents in paper version and converting the documents into electronic files; faxing electronic versions of documents, i.e. an insurance policy or an appraisal and the completed insurance application; uploading or downloading electronic versions of the appraisal and the completed insurance application to or from a website and/or database belonging to the II 35 or the IP 45; and causing a printer to print paper versions of the appraisal and the insurance application which have been produced or retrieved on the II-C 30 or the IP-C 40.

Connectivity 18 between the POS-C 15, email server 16, II-C 30 and/or IP-C 40 may include, but is not limited to, long range wireless connections, short range wireless connections, and various wired connections including, but not limited to, telephone lines, cable lines and the like.

FIG. 1 is exemplary of an embodiment of the present invention using email as the communication method; however, communication between a POS 10, an II 35 and an IP 45 can be accomplished by any number of methods which enables the content of documents to be communicated from one location to another location, including, but not limited to, uploading and downloading to or from internet websites, fax transmission or by mail in the United States Postal Service.

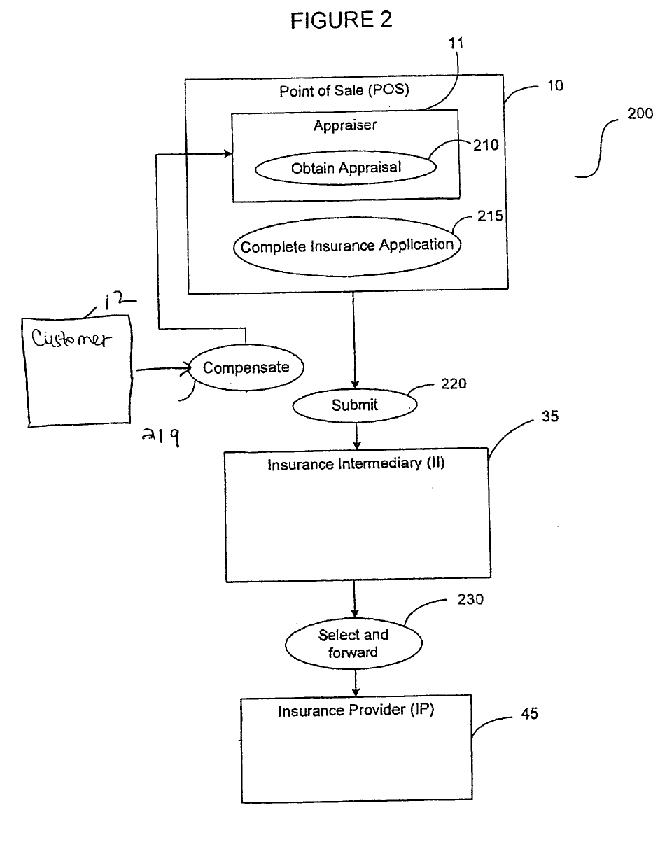

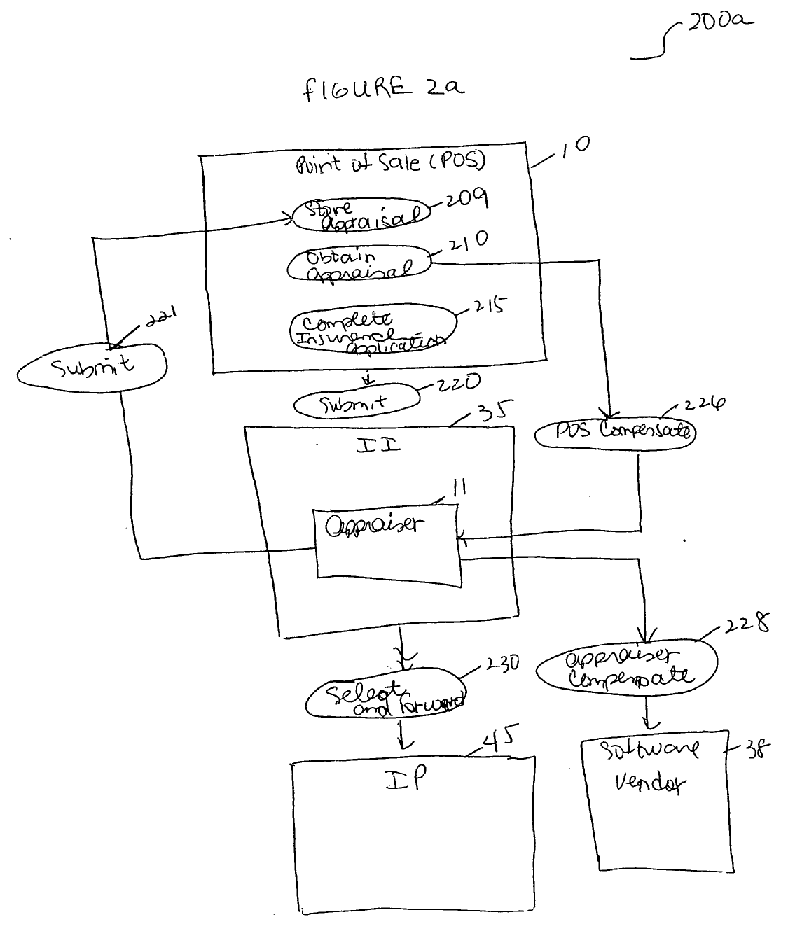

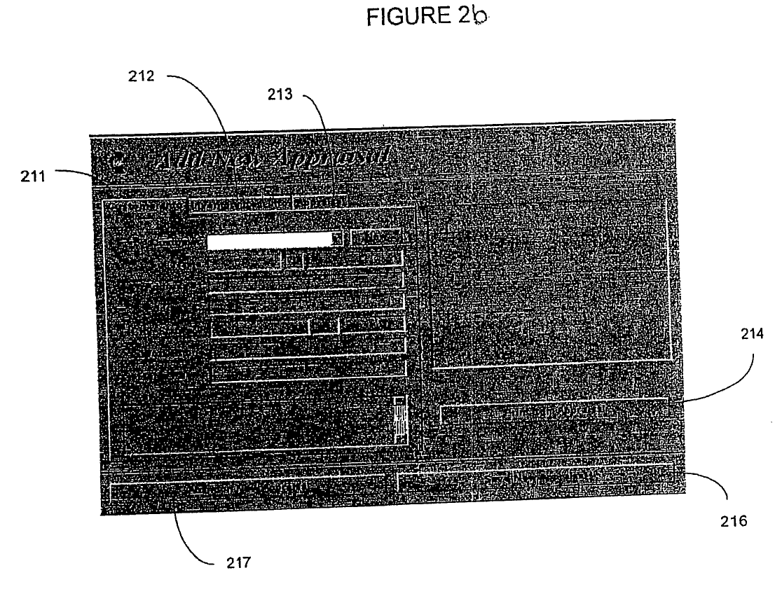

In FIG. 2, an exemplary flowchart illustrates a method 200 for applying for point of sale insurance according to an embodiment of the present invention. In the method described in FIG. 2, a customer 12 has purchased jewelry at a point of sale 10 and has decided to begin the process to apply for insurance on the jewelry product that has been purchased. The term “jewelry product” as used herein, means one or more articles of jewelry including, but not limited to, one earring or a pair of earrings, a necklace, a pendant, a ring, a bracelet and/or a gem i.e. diamond, ruby, sapphire.

Referring to FIG. 2, in step 210, an appraisal is obtained at the point of sale 10. The term “obtained” as used herein, is the process whereby documentation associating the identity of a jewelry product with its appraisal value is generated. In step 219, the customer 12, in response to the point of sale obtaining the appraisal, compensates the point of sale 10 for the appraisal. The point of sale 10 representative may or may not be an appraiser.

The appraisal value can be determined through any process leading to the assignment of an appraisal value to a jewelry product, including, but not limited to, using software which merges an appraisal value that has been created by an appraiser in the past and stored in a database before the time of purchase with information on the corresponding jewelry product that has also been stored in the database before the time of purchase; or causing an appraiser 11 to evaluate a jewelry product and assigning the jewelry product an appraisal value at the time that the jewelry product is purchased. The appraiser can be located at the POS 10 (as shown in FIG. 2).

Alternately, the appraiser 11 can be located at a location other than the POS 10 (as shown in FIG. 2a). As shown in FIG. 2a, the appraiser can be located at a central location, such as at the II 35, and can regularly perform appraisals for jewelry products in the inventory of various POS 10, and can distribute the appraisal to a POS 10 before the jewelry products are purchased at the POS 10. The appraiser can distribute one or more appraisals to all POS 10 to which the appraiser can communicate and/or to all POS 10 having the appraised jewelry product in their inventories. The distribution can occur by any method that allows a POS 10 to receive either an electronic or paper appraisal. For instance, the appraiser can communicate an appraisal at a single time or at different times to any or all POS 10 to which it is connected by computer by transmitting an electronic version of the appraisal to the website from which the POS-C 15 can download or by email which the POS-C 15 can retrieve. Alternately, the appraiser can communicate an appraisal at a single time or at different times to any or all POS 10 by sending the appraisal through the U.S. postal mail, by fax or by other methods of communicating information. As shown in step 209 of FIG. 2a, each point of sale receiving an appraisal from the appraiser 11 can store the appraisal in a system such as VI POS. As shown in step 226, the point of sale 10 can compensate the appraiser 11 each time that the appraisal is obtained from the database in which the appraisal is first stored when the appraiser 11 sent the appraisal to the point of sale 10.

Referring back to FIG. 2 in step 210, the appraisal documentation can be generated, and therefore the appraisal can be obtained, through any number of means that produces a document that communicates the contents of the identity and the appraisal value of a jewelry product to the II 35 and/or the IP 45, including, but not limited to, software which can generate a formatted appraisal, a document produced by hand, typed or generated by any word processing system. Further, the appraisal document can be in paper or electronic format.

One exemplary software product which can be used to generate appraisal documents is the Virtual Inventory Point of Sale module (“VI POS module”) which is one of a suite of Virtual Inventory (“VI”) software modules. The VI POS module can generate an appraisal for jewelry that is either located within a VI database that is accessible by the VI POS module or that is not located within the VI database that is accessible by the VI POS module.

The VI POS module can generate an appraisal for jewelry that is located within a VI database that is accessible by the VI POS module by merging previously stored jewelry product appraisal information with customer contact information.

For example, FIG. 2b is an exemplary illustration depicting a VI POS user interface for generating an appraisal document at a point of sale when the jewelry product is in a VI database that is accessible by the VI POS module. At the startup of the VI system, a VI operator can depress an Appraisal button and then depress an Add New Appraisal button to arrive at the Add New Appraisal page which contains the user interface shown in FIG. 2b. The Add New Appraisal page contains a Customer Info tab 211, an Inventory Item Info tab 212, and an Appraisal tab 213.

Selecting the Customer Info tab 211 displays a page containing a user interface with fields that the VI operator can populate with information pertaining to the customer receiving the appraisal. As used herein, the term “fields” means spaces allocated for information. A VI operator can populate fields through the use of any number of methods including, but not limited to, selection of text from pull-down menus or typing in text manually. Selecting the Inventory Item Info tab 212 displays a page containing a user interface with fields in which the VI operator can input or select, via a pull-down menu, text describing the identity of the jewelry product for which an appraisal is being generated. Selecting the Appraisal tab 213 displays a page containing a user interface with fields in which the VI operator can input or select, via a pull-down menu, appraisal information. The VI operator can use a pull-down menu to retrieve an appraisal value and other information that has been pre-stored in the VI database. The foregoing method described with reference to FIG. 2b is merely exemplary and the VI operator can select the tabs, and populate the fields on each page that correspond to each tab, in any order. Additionally, various fields can optionally be left in an unpopulated state and an appraisal can still be generated.

Referring to FIG. 2b, in order to generate the appraisal, the VI operator can select the Customer Info tab 211 and populate the fields with information pertaining to the customer. If the customer is already in the VI database, the customer information can be retrieved by selecting the customer's name from a pull-down menu associated with the input location for the customer's name. The other fields for which information about the customer is stored in the VI database will be automatically populated as a result of selecting the customer's name from the pull-down menu. If the customer is not already in the VI database, the VI operator can depress the New button 218 and enter the customer's information. The VI operator can then select the Inventory Item Info tab 212 and enter information about the identity of the jewelry product being appraised or use a pull-down menu and select information about the identity of the jewelry product being appraised. The VI operator can then select the Appraisal tab 213 and enter appraisal information for the jewelry product. If an appraiser has already appraised the jewelry product and the appraisal information has been stored in the database, the VI operator can use a pull-down menu to retrieve the appraisal information. If appraisal information is not already stored in the database, an appraiser can evaluate the jewelry product and populate the fields with information such as the appraisal value. To generate the appraisal, the VI operator can then depress the Print Item Appraisal button 214 or depress the Save New Appraisal button 216 to generate the appraisal in paper or electronic formats, respectively. The VI operator can abandon the appraisal by depressing the Abandon New Appraisal 217 button. To speed the process of writing the appraisal, a series of basic templates can be selected with general information about a specific product category. Information of a specific nature for the specific product being appraised can be filled in by the appraiser thus eliminating repetition of phrasing that is need to describe particular products.

The VI POS module can also generate an appraisal for jewelry that is not within a VI database by having an appraiser evaluate and input the appraised value and related information into the VI POS module, capture an image of the jewelry with a device such as a camera or any other device capable of capturing an image, and merge the jewelry information with the customer contact information in an appraisal document.

The appraisal generated by the VI POS module can include various pieces of information, including, but not limited to, the type of jewelry product being appraised; the type and weight of the stone within the jewelry product; replacement cost of the jewelry product; a short paragraph describing the jewelry product; and a designated location for the appraiser 11 to sign and date the appraisal document.

The VI software can also include functionality enabling it to perform a host of other varied operations including, but not limited to, functionality which allows the operator to maintain customer personal and purchase-history information; print product sales tags; maintain and track repair and jewelry-adjustment jobs, maintain a pictorial inventory of jewelry, track and search inventory and record sales; generate, deliver and/or print customized electronically definable catalogs; encrypt jewelry price information, sales and vendor analysis; facilitate inventory exchange with other VI software owners; send emails that contain particular company brand information; perform data compression, website administration or inventory tagging; search the VI database and/or customized electronically definable catalogs; operate VI over multiple databases; import or export of data; perform system security for different classes of users; and perform pictorial job bagging and file containment. Steps to operate the VI software to perform these and other functions are described in the Virtual Inventory Manual.

One exemplary function of the VI software is the ability to create customized electronically definable catalogs. The electronically definable catalogs can include functionality which allows for: personalized messaging; direct transmissions to and from a website; presentation of jewelry products and associated information; searching catalogue; printing catalogue; making multi-media presentations; online or offline displaying and/or viewing of jewelry product images and/or text; displaying jewelry product images and text simultaneously on the same page; creating thumbnail representations of jewelry product images; creating customized catalogs for specific customers or customer prospects based on data mining; enabling two or more VI operators to send, receive and share data allowing items transmitted from a sending user to be automatically incorporated into the database of a receiving user.

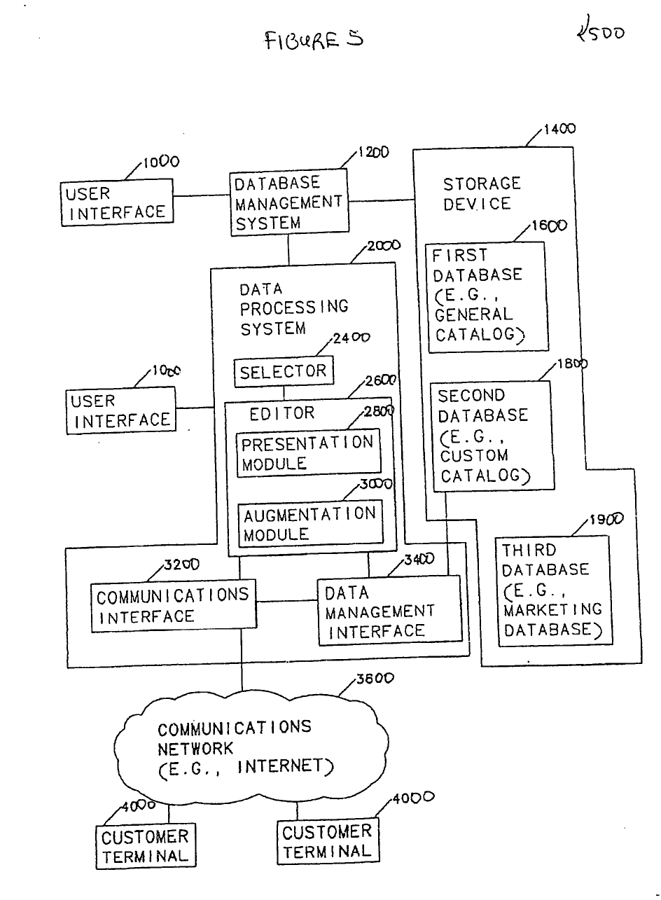

FIG. 5 shows an embodiment of a system 500 for formation of an electronically definable catalog and distribution of the electronically definable catalog via a communications network 3600. A user interface 1000 is coupled to a database management system 1200. In turn, the database management system 1200 is coupled to a storage device 1400. The storage device 1400 may store at least one of a first database 1600, a second database 1800, and third database 1900. The database management system 1200 is associated with a data processing system 2000.

The data processing system 2000 may communicate to one or more customer terminals 4000 over a communications network 3600. The communications network 3600 is comprised of one or more of the following components: the Internet, an intranet, a public-switched telephone network, a data packet communications network, and any other suitable communications network.

A user interface 1000 is coupled to the data processing system 2000 for entering a user preference, selection, or other user input related to the formation and distribution of the electronically definable catalog. The data processing system 2000 comprises a selector 2400 that communicates with an editor 2600. In turn, the editor 2600 may communicate with a communications interface 3200, a data management interface 3400, or both.

The storage device 1400 may store marketing data or demographic data, or customer specific data in a marketing database or a third database 1900. The selector 2400 may be used in selection of a group of one or more catalog entries from the first database 1600 based on marketing data for at least one targeted customer.

The editor 2600 supports organization of a group of catalog entries to form an electronically definable catalog. In general, the electronically definable catalog can contain entries that are targeted toward a certain customer group or targeted customer audience, rather than all of the entries (e.g., the comprehensive scope of entries) found in the first database 1600 or a general catalog. The first database 1600 may represent all of the products or goods which may be provided by a certain store, seller, or supplier.

Each catalog entry may include a visual component and a textual component. The visual component generally comprises an image of the good or product offered for sale. For example the visual component may comprise a JPEG file, a TIFF image file, an MPEG file, or another file for storing and representing the image. JPEG (Joint Photographic Experts Group) refers to a standard data compression technique for compressing an image file. MPEG (Moving Picture Experts Group) refers to a standard data compression technique for storing a digital video file. TIFF (tagged image file format) refers to a format for storing bit-mapped images, which may represent color or black and white images. Virtually any file format can be presented within the catalog.

The editor 2600 can include a presentation module 2800 for manipulating the presentation or appearance of the electronically definable catalog in a desired manner in conformance with user input entered one or more user interfaces 1000. Similarly, the augmentation module 3000 can support a user's augmentation or addition of supplemental data to catalog entries retrieved from the first database 1600. The addition of supplemental data supports flexibility and customization in the definition of the electronically definable catalog. In one example, the user interface 1000 supports entry of supplemental data or augmentation data from a user interface 10 to supplement or vary the entries of an electronically definable catalog from the entries available in the first database 1600. In another example, the user interface 1000 supports selection of supplemental data or augmentation data from a database (e.g., a marketing database) in the storage device 1400.

The editor 2600 can organize an order in which the sorted catalog entries appear in an electronically definable catalog. The editor 2600 can comprise an augmentation module 3000 to augment at least one of the sorted catalog entries within the textual data 7300 defining the product.

The editor 2600 can organize a group of selected catalog entries into an electronically definable catalog. The data management interface 3400 is coupled to the editor 2600. The data management interface 3400 stores the electronically definable catalog in a storage device 1400 (e.g., the second storage device).

The data management interface 3400 can support storage of selected and edited entries as an electronically definable catalog within the second database 1800. Although the database management system 1200 and the data processing system 2000 are shown as separate components in FIG. 1, the database management system 1200 and the data processing system 2000 may be combined or integrated in an alternate data processing system.

The data management interface 3400 may support retrieval of the stored electronically definable catalog from the storage device 1400 (e.g., the second database 1800) in preparation for transmission of the stored electronically definable catalog in response to the occurrence of a triggering event. The triggering event may comprise one or more of the following: a customer-specific event, a birth date of the customer, an anniversary of the customer, a planned wedding of the customer, an upcoming celebration of the customer, an upcoming holiday, and the expiration of a time interval. A simple user request can trigger the compilation of an electronically definable catalog, including the launch and delivery of the electronically definable catalog within seconds or minutes of a user request.

The electronically defined catalog may be distributed to a customer or a customer terminal via a communications network 3600 or via a storage medium (e.g., optical disk). The customer terminal 4000 may refer to one or more of the following: a personal computer, a computer, a POS-C 15, a web-browser, an Internet appliance, a client in a client-server network, a wireless communications device, a web-access-protocol wireless communications device, and other communications devices.

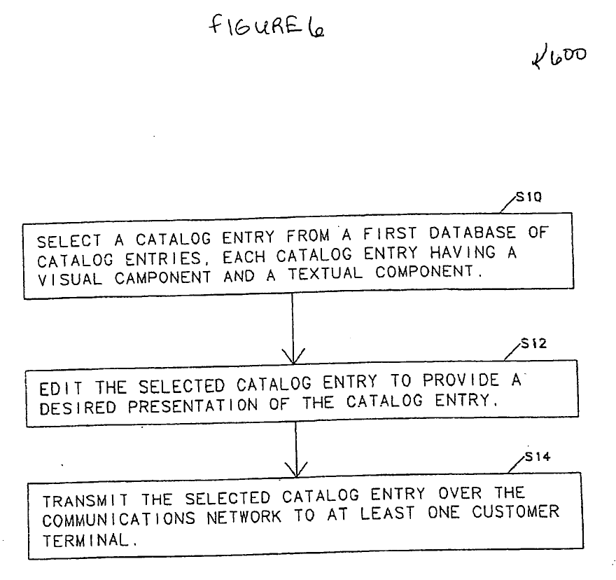

FIG. 6 shows a method 600 for distribution of an electronically definable catalog via a communications network 3600 in accordance with an embodiment of the invention. The method of FIG. 6 can start at step S10.

In step S10, a user selects one or more catalog entries from a first database 1600 of catalog entries. Each catalog entry may have a visual component and a textual component. The visual component may comprise an image or image data of the good or product offered for sale. The textual component may include product data. The product data may include one or more of the following: selling price, description, catalog number, quality, size, weight, color, construction materials, composition, specifications, manufacturer, trademark, manufacturer model identifier (e.g., model number), or any other data that may be pertinent to a customer's purchase of a good or product. In one embodiment, the first database 1600 of catalog entries may include a general catalog of most or all of the products or goods offered by a seller or a supplier.

In one example of step S10, a user may select a catalog entry via a user interface 1000. The selector 2400, as controlled by the user interface 1000, supports the selection of the entries from the first database 1600. The selector 2400 may permit the user to search the catalog entries of the first database 1600 based on product attributes, such as product price, product identifier, product description, or other product characteristics to develop a targeted list of products that the user deems appropriate for one or more targeted customers. For example, the selector 2400 may facilitate selection of a group of catalog entries from first database 1600 based on the marketing data in the third database 1900 matching or coinciding with at least one product characteristic that is potentially preferred or sought by at least one targeted customer.

In step S12, the editor 2600 can support a user's editing of the selected catalog entry or entries to provide a desired presentation of the selected set of catalog entries. The editor 2600 can edit the selected set of catalog entries through the selection or entry of input data by a user via the user interface 1000 or otherwise. The editing of step S12 may comprise organizing an order of presentation in which the selected catalog entries appear in an electronically definable catalog. In another example the editing may include augmenting at least one of the selected catalog entries with supplemental textual data defining the product. The supplemental textual data may include personal data relevant to the targeted customer or audience. The supplemental data may comprise presentation of the products in the second language or a bilingual fashion.

In step S14, the data processing system 2000 can support distribution of the selected set of catalog entries, which form the electronically definable catalog. Step S14 may be executed in accordance with several alternate techniques. In accordance with a first distribution technique, the communications interface 3200 transmits the electronically definable catalog over the communications network 3600 to at least one customer terminal 4000. For example, the communications interface 3200 may retrieve a list of customers from a database of the storage device 1400 and automatically broadcast or transmit the electronically definable catalog to each customer on the customer list. The members of the customer list may be selected to coincide with the customer specific data, marketing data, or other data used to select the catalog entry in the selection step S10. Accordingly, the formation of the catalog and distribution of the catalog may be coordinated to focus on a particular set of targeted customers.

In accordance with a second distribution technique, the data processing system 2000 can record or copy the electronically definable catalog onto a recording medium for distribution via mail or otherwise. The recording medium may include a magnetic disk, a floppy disk, an optical disk, a compact disk, tape, or another storage medium that may be readily mailed or delivered to targeted customers.

In accordance with a third distribution technique, the communications interface 3200 can transmit the electronically definable catalog over the communications network 36 to at least one customer terminal in response to the occurrence of a detected triggering event. In preparation for distribution consistent with the third distribution technique, the electronically definable catalog is stored in a second database 1800 of the storage device 1400. In response to the occurrence of a triggering event, the data management interface 3400 may retrieve the stored electronically definable catalog from the storage device 1400 in preparation for transmission of the stored electronically definable catalog. Further, the communications interface 3200 may transmit the stored data from the second database 18 in response to the occurrence of a triggering event.

The triggering event may comprise a customer-specific event or another event, including one or more of the following events: a birth date of the customer, an anniversary of the customer, a planned wedding of the customer, an upcoming celebration of the customer, an upcoming holiday, and the expiration of a time interval.

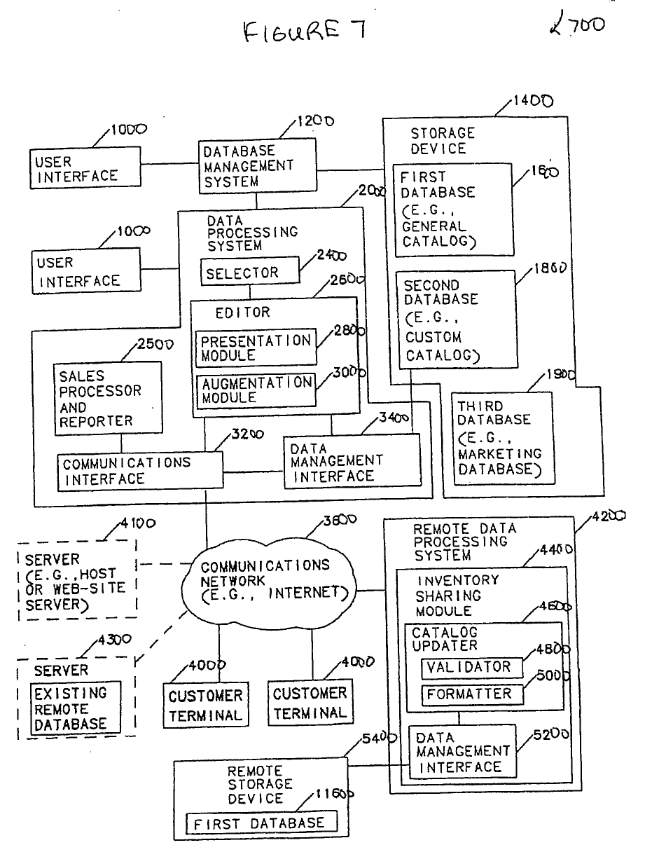

FIG. 7 is a block diagram of a system 700 for sharing inventory between trading partners in accordance with an embodiment of the present invention. The infrastructure of FIG. 5 and FIG. 7 can be generally the same except FIG. 7 can further include a remote data processing system 4200 coupled to the communications network 3600. Like reference numbers in FIG. 7 and FIG. 5 indicate like elements.

The remote data processing system 4200 of FIG. 7 can comprise an inventory-sharing module 4400 to promote the sharing of inventory or catalog entries between a first trading partner and a second trading partner. A trading partner may include a supplier, a store, a retail chain, a distributor, or a seller of a good or product. The first trading partner may be associated with the data processing system 2000, whereas the second trading partner may be associated with the remote data processing system 4200. The first trading partner and the second trading partner may be separated by minor geographic distances (e.g., within the same metropolitan area, city, or state) or great geographic distances (e.g., different cities or countries).

The data processing system 2000 can transmit an inventory-sharing file (e.g., a viewer file 6000 that can incorporate an electronically definable catalog) to the remote data processing system 4200 for updating the data in the remote storage devices 5400. The remote data processing system 4200 can revise the remote storage device 5400 (e.g., the first database 1600 within the remote storage device 5400) to contain a general catalog or first database 1600, which represents a pool of common inventory that may be sold by the first trading partner, the second trading partner, or both. Although the diagram of FIG. 7 is simplified for improved understanding, the update of the first database 1600 of the first trading partner and the remote first database 11600 of the second trading partner may be bi-directional, consistent with transmission of inventory-sharing files in one or more directions between the data processing system 2000 and the remote data processing system 4200. Accordingly, the data processing system 2000 may include an inventory sharing module (e.g., module 4400) to facilitate such bi-directional updating of the first database 1600.

Consistent with FIG. 7, the first database 1600 of the first trading partner and the remote first database 11600 of the second trading partner can both contain the common pool of catalog entries to facilitate inventory sharing. The inventory sharing module can support the updates of the remote first database 11600 of the remote storage device 5400 to contain the pool of common custom entries.

In one embodiment, the inventory-sharing module 4400 includes a catalog updater 4600 coupled to a data management interface 5200. The catalog updater 4600 may include a validater 4800 and a formatter 5000. The validater 4800 may authenticate the genuineness or authenticity of the inventory-sharing file or electronically definable catalog received from the first trading partner via the communications network 3600. The validater 4800 represents a security measure to prevent unauthorized tampering or corruption of the records within the remote storage device 54 by an unauthorized user via the communications network 3600.

The formatter 5000 may check the data structure of the received electronically definable catalog or viewer file 6000 to confirm that the received format complies with the defined parameters of a reference format stored in or accessible by the formatter 5000. If the format does not comply with the defined parameters the user may be prompted via the remote data processing system 4200 or the formatter 5000 may be configured to automatically reformat the inventory-sharing file, or the electronically definable catalog integrated therein, to be compatible with the storage and retrieval arrangement of the remote first database 11600 within the remote storage device 5400. The remote data management interface 5200 supports querying and data storage and retrieval of catalog entries from one or more databases within the remote storage device 5400.

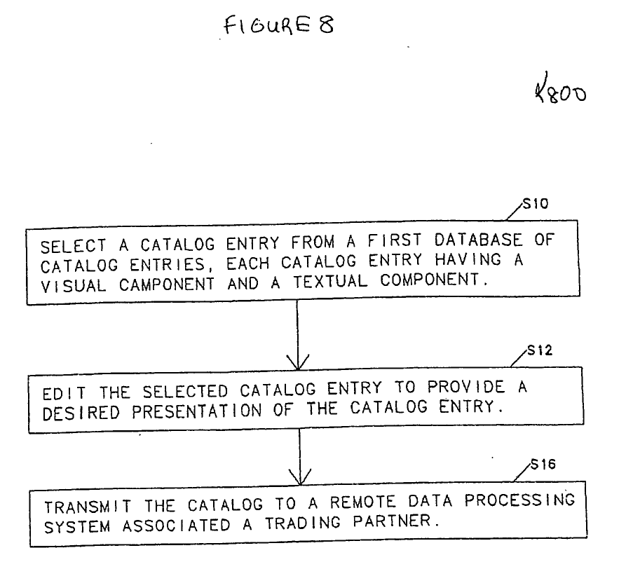

FIG. 8 is a flowchart of a method 800 for supporting the sharing of inventory between trading partners in accordance with an embodiment of the present invention. Like reference numbers in FIG. 8 and FIG. 6 indicate like procedures or steps.

The method of FIG. 8 can start with step S10 which can be followed by step S12. After step S12, the method of FIG. 8 can continue with step S16. In step S16, the data management interface 3400 of the data processing system 2000, associated with the first trading partner, can transmit the inventory-sharing file to a remote data processing system 4200 associated with a second trading partner.

The remote data processing system 4200 may update at least the remote first database 11600 or an inventory database within the remote storage device 5400 based upon the transmitted inventory-sharing file. Further, the remote data processing system 4200 may update a remote database 11600 based on the transmitted inventory-sharing file (or a catalog therein) after first validating the authenticity of the transmitted inventory-sharing file and adjusting the format of the inventory-sharing file to be compatible with the remote first database 11600 or another database.

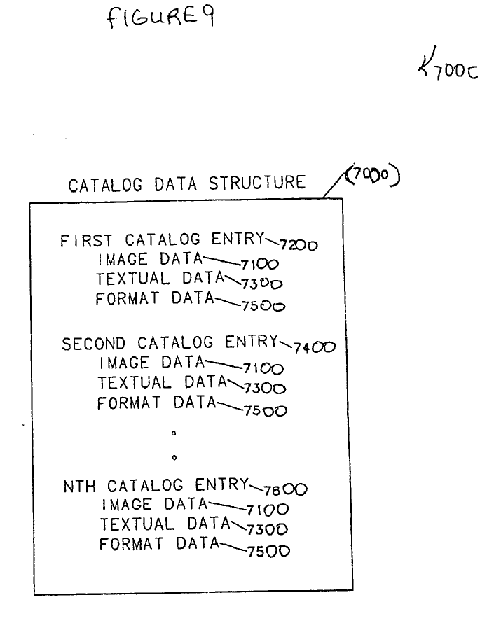

FIG. 9 shows an illustrated data structure 7000 of an electronically definable catalog according to an embodiment of the present invention. An electronically definable catalog generally can comprise a group or ordered series of catalog entries. For example, the catalog entries may include a first catalog entry 7200, any intermediary catalog entries (a second catalog entry 7400), and an Nth catalog entry 7600, where N refers to the maximum number of catalog entries. The maximum number of catalog entries may be commensurate with a maximum file size (e.g., a maximum viewer file size) that may be stored on a particular storage medium, a maximum file size that may be transmitted over the communications network to a customer terminal 4000 within a maximum time interval (e.g., five minutes), or both. The maximum file size may be proportional to the transmission capacity of the communications network 3600 (e.g., the Internet) or a portion thereof.

Each catalog entry (7200, 7400, 7600) may include image data 7100 on a sales item, textual data 7300 on a sales item, format data 7500. The sales item can refer to a good or product that is offered for sale. The user interface 1000 may support the entry of the image data 7100 in the form of an image file inputted into the database management system 1200 for storage in the first database 1600. For example, the image file may be stored as a TIFF, an MPEG file, a JPEG file, or another suitable data format. Similarly, the user interface 1000 may support the entry of the textual data 7300 on a sales item. For example, the user interface 1000 may support the entry of textual data 7300 on the sales item or a textual file for one or more sales items. The user interface can support entry or manipulation of the format data 7500 or other organizational data.

In one example, the selector 2400 for the data processing system 2000 retrieves the image data 7100 and the textual data 7300 as an entry or selection from the first database 1600 for formation of an electronically definable catalog or viewer file 6000.

The editor 2600 may support a desired organization and format of the textual data 7300 through user input entered via the user interface 1000 of the data processing system 2000. The user interface 1000 of the data processing system 2000 may provide user input to the presentation module 2800 and the augmentation module 3000 to form format data 7500 and supplemental data. The textual data 7300 of FIG. 9 may include supplemental data as entered or otherwise defined by a user.

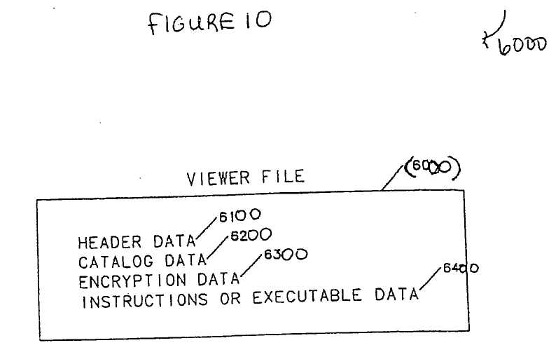

In FIG. 10, an illustrative data structure of a viewer file 6000 is shown according to an embodiment of the present invention. The viewer file 6000 generally comprises at least an electronically definable catalog. For example, the electronically definable catalog, illustrated in FIG. 9, may be incorporated or integrated into the viewer file 6000 of FIG. 10 as catalog data 6200. Further, the viewer file 6000 comprises header data 6100, encryption data 6300, and instructions or executable data 6400. The header data 6100 refers to reference data or indexing data for at least one of the catalog data 6200, the encryption data 6300, and the executable data 6400 that facilitates a processor's reading and processing of the viewer file 6000.

The encryption data 6300 may scramble, encode, or encrypt both the catalog data 6200 and the executable instructions. The encryption data 6300 may be thought of as a shell that encapsulates both the catalog data 6200 and the executable data 6400. The encryption shell can be removed by the customer terminal 4000 by the entry of a proper code, password, login identifier, or other verification scheme.

Executable data 6400 can refer to instructions for displaying or interacting with the electronically definable catalog at a customer terminal 4000. The viewer file 6000 can generally be a self-executing file that does not require additional software programs other than an operating system to support it. Further the executable data 6400 may be configured to be compatible with multiple operating systems or multiple versions of the executable data 6400 may be included in each of the viewer files 6000 to support multiple platforms to attain the widest possible dissemination of the electronically definable.

The electronically definable catalog may be distributed via an electronic communications network 3600, or via an optical disk, a magnetic disk, a magnetic tape, or another storage media. In one embodiment, the instructions provide self-executable code that is compatible with one or more operating systems to promote platform independence and broad interoperability on a wide assortment of client terminals 4000 of divergent types.

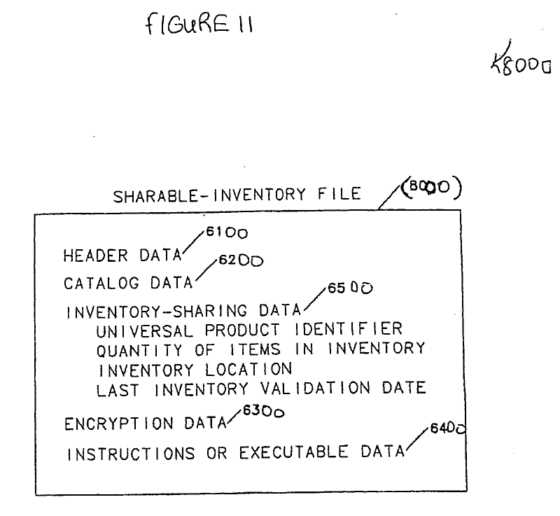

FIG. 11 provides a data structure of a sharable-inventory file 8000 that may be well suited for inventory sharing between two or more trading partners in accordance with an embodiment of the present invention. The illustrative data structure of FIG. 11 can represent a modification of the data structure of FIG. 9 or FIG. 10, for example. The data structure of FIG. 11 can use specific textual data, called inventory-sharing data 6500, to support inventory sharing among multiple trading partners. Like reference numbers indicate like elements in FIG. 10 and FIG. 11.

In one example, the inventory-sharing data 6500 may include a product identifier, such an SKU number (e.g., a vendor-specific product identifier) or a Universal Produce Code (UPC). The data may also include the number of available items of a certain good type that can be sold, the number of good items which are placed on hold or already sold, the total number of items in inventory, and the associated location of the inventory.

For example, both the first trading partner and the second trading partner may have warehouses for storing goods. The first trading partner may have a first warehouse with a first storage location identifier and the second trading partner may have a second warehouse with a second storage location identifier so that such information may be provided within the data structure of FIG. 11 to facilitate sharing of inventory among the first trading partner and the second trading partner.

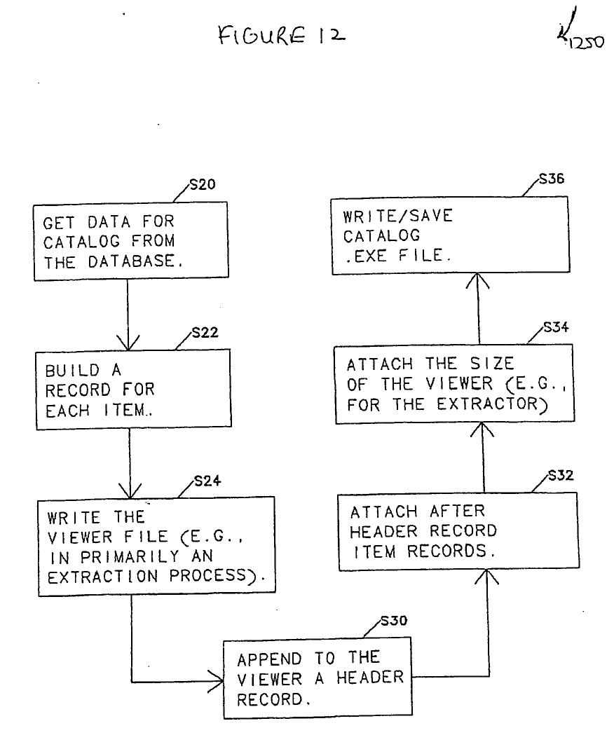

FIG. 12 shows a method 1250 of forming a viewer file 6000 of FIG. 10 or another data structure in accordance with an embodiment of the present invention. The viewer file 6000 can incorporate the electronically definable catalog data structure 7000 of FIG. 10 as catalog data 6200. The data processing system 20 may support the formation of the viewer file 6000 as shown in FIG. 12. The method of FIG. 12 can start at step S20.

In step S20, the data processing system 2000 can get data for the electronically definable catalog from a database (e.g., the first database 1600).

In step S22, the data processing system 2000 can build a record for each item where the item represents a good or product to be offered by the supplier or seller. The record may comprise image data 7100 and textual data 7300. The record may also include format data 7500 related to the image data 7100 and the textual data 7300. In one embodiment, the records are stored in a suitable binary format, although the records may be stored in other formats.

In step S24, the data processing system 2000 can write the viewer file 6000 or assemble the viewer file 6000. First, the assembly of the viewer file 6000 can comprise an extraction process in which multiple records are assembled into a cohesive electronically definable catalog or catalog data 6200 based upon marketing data or other information. Second, the executable data 6400 can be appended onto the viewer file 6000. Third, the encryption data 6300 can encrypt the catalog data 6200 and the executable data, or both.

In step S30, the data processing system 2000 may append a header to the encrypted, assembled viewer file 6000. Accordingly, the viewer file 6000 can comprise records that comprise image data 7100 and textual data 7300 for each product or good and a header that contains reference data. For example, the reference data may define one or more of the following: the number of items in the viewer file 6000, the overall size of the viewer file 6000, the size of each item in the viewer file 60, the size of the executable data in the viewer file 6000, the reference address (e.g., starting address) of each item in the viewer file 6000, the reference address (e.g., starting address) of the executable data 6400 or a portion of the executable data, and other data on the overall catalog. In general, the header record precedes the item record in the viewer file 6000.

In step, S34, the overall size of the viewer file 6000 can be determined and stored in the header of the viewer file 6000. The overall size of the viewer file 6000 can be determined after all of the items are selected by the selector 2400 or the data processing system 2000 for inclusion in the catalog data 6200.

In step S36, the data processing system 2000 can write and save the viewer file 6000 in a database as an executable file, such as an executable file (e.g., an .EXE file in a windows environment).

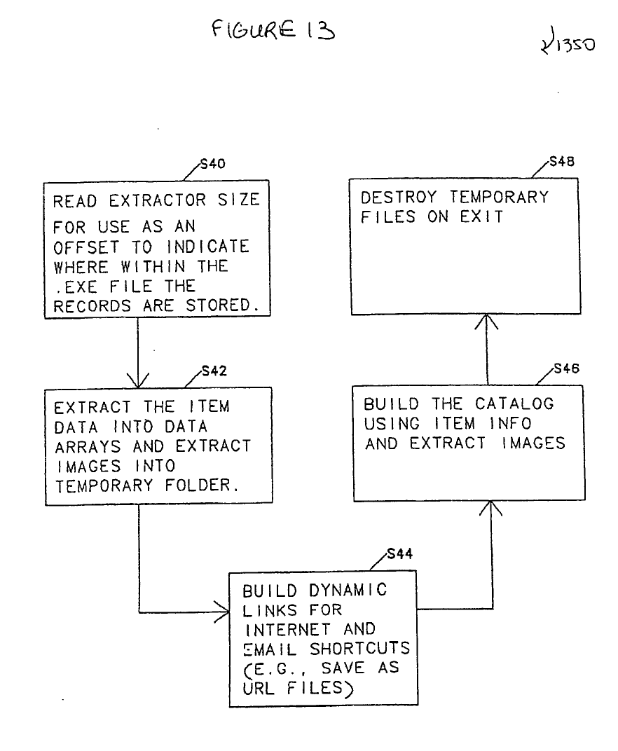

FIG. 13 shows a method 1350 of extracting the catalog data 6200 or the definable catalog from the viewer file 6000 in accordance with an embodiment of the present invention. The method of FIG. 13 may be carried out at a customer terminal 4000, for example. The method of FIG. 13 can begin at step S40.

Starting at step S40, the customer terminal 4000 can determine a viewer file size of a viewer file 6000. For example, the customer terminal 4000 can read a viewer file size within a header of the viewer file 6000. The viewer file size may be used to determine an extractor size or an extraction address. The extraction size may represent an address offset to indicate where within the executable viewer file 6000 (e.g., the .EXE file) the records or catalog data 6200 are stored. Accordingly, the extractor address or the extractor size provides address references within the viewer file 60 for retrieving the entire catalog data 6200 or the appropriate items of an electronically definable catalog. The customer terminal 4000 may decrypt the viewer file 6000, prior to, during or after step S40.

In step S42 after the viewer file 6000 is decrypted, the customer terminal 4000 can extract items of data from the viewer file 6000 into a relational data structure (e.g., data arrays). The items may be stored one by one into a data array, a table, a relational database, or another suitable relational data structure. The table may have fields for each item. Further, image data may be extracted into a temporary folder defined by an operating system of the customer terminal 4000.

In step S44, the customer terminal 4000 can support a communications interface between the customer terminal 4000 and the data processing system 2000 via the communications network 3600 or other resources. The resources may include servers under the control or direction of trading partners, or the like. The communications interface establishes communications features, such as dynamic links or associations for internet and e-mail shortcuts. The dynamic links may be saved as URL files, for example. URL refers to Uniform Resource Locator, which is a global address for documents and other resources accessible through the Internet. The first part of the URL defines a protocol to be used and a second part specifies an Internet protocol (IP) address or the domain name where the resource is located.

In step S46, the electronically definable catalog can be extracted from the viewer file 1000 and assembled. The electronically definable catalog can be assembled by extracting the images from the temporary folder and associating the item data from the arrays to form a presentation in a desired presentation format. USWG item information can support the desired format of the display. USWG refers to user services working group of the internet engineering task force (IETF).

In step S48, the client terminal 4000 can destroy or authorize overwriting of the temporary files created during the extraction process for reading of the viewer file 6000.

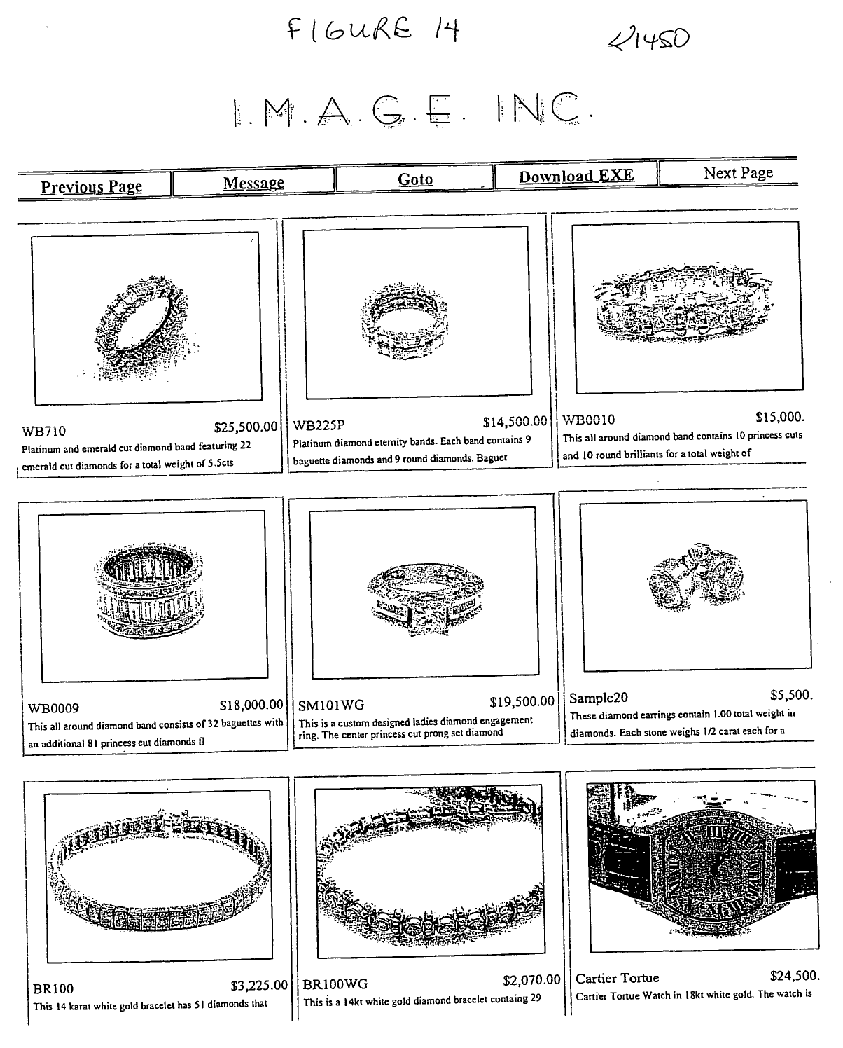

FIG. 14 shows an illustrative arrangement 1450 of an electronically definable catalog as it might be displayed to a user on a customer terminal 4000 in accordance with an embodiment of the present invention. As shown in FIG. 14, nine items, or products, are shown, although in other embodiments any number of items may be shown on a single page or within an electronically definable catalog. Similarly, the presentation of FIG. 14 can comprise items that are related to jewelry goods, although the method and system of this invention is applicable to virtually any product, good or item.

The images shown in the example of FIG. 14 may be carried out by the employment of JPEG files, TIFF files, image bitmaps, or image data to provide color or black-and-white representations of the product or good offered for sale. Each catalog item may include textual data, such as an item number and a price, along with a description of the item, or other textual data. As shown in FIG. 14, the textual data can be located beneath each of the images of an item and the price and part or model number are shown in bold.

Certain data shown on the representation of FIG. 14 can be supplemental data that may be provided by the augmentation module 3000. For example, such supplemental data may include a company logo, for example, which may be located at the top of a page, the address, phone number, fax number or other email information about a supplier. Although the elements are arranged as shown in FIG. 14, the editor 2600 can comprise a presentation module 2800 and an augmentation module 3000 for customizing the presentation of the electronically definable catalog to select the preferences of the salesperson or user preparing the electronically definable catalog.

The contents of the electronically definable catalog may be based upon marketing data or customer-specific data gained through previous customer contacts with customers, purchased from marketing agencies, or a latest governmental census. Demographics information may include one or more of the following: residential address of the customer, zip code of the customer, telephone number of the customer, the income of the potential customer, historic purchases of the customer based upon price, historic purchases of the customer based upon frequency of the purchases or dates of the purchases, types of items purchased, and any other marketing information. The user may use such information to select the appropriate entries or items from the general catalog to construct an electronically definable catalog for delivery to the customer. Such customized catalogs may be tailored to different demographic groups or otherwise and sent via email, data packets, or electronic data messages via a communications network 36. For example, the electronically definable catalog may be distributed via the communications network 36 without the expense of hiring printing companies, checking proofs of prints, shipping and sorting and mailing such catalogs such that companies using the method of distributing the electronically definable catalog of the invention may save considerable amounts of resources and funds that otherwise may be incurred through traditional assemblage and mailing of catalogs.

Further, because the contents of the traditional catalogs are changed after a certain lag time or delay, updates to the electronically definable catalogs due to price fluctuations, especially in an inflationary or volatile markets for goods may be updated on a regular or almost instantaneous basis to remove the risk of the transaction from the supplier, store, or seller. Such a risk is best understood by an example where an existing catalog is outstanding and it is not possible to economically or physically update the catalog in time to avoid an imminent or a previous price increase in raw materials or the price of the underlying product being offered via the catalog.

Another advantage of the embodiments of the present invention is that the electronically definable catalog may be transmitted to a targeted customer in accordance with a regular schedule or based upon the occurrence of a customer-specific event, such as marriage, anniversaries or birthdays. The ability to target customers in such a manner may lead to increased sales and greater market penetration than traditional methods which rely upon group numbers of distribution of general catalogs at great expense.

Although the images in FIG. 14 represent still images, in alternate embodiments, the images may represent multimedia images, moving images, such as MPEG images, streaming video, streaming audiovisual images, sales presentations or other formats. The format of the image data or presentational data may be commensurate with the available bandwidth of the communications network 3600 and the processing capabilities of the customer terminal 4000 as well as the bandwidth of the communications access of the customer terminal 4000. For example, the bandwidth of the communications access may be related to the maximum data rate of the link between the customer terminal 4000 and the communications network 3600 or the maximum data rate of the physical or virtual channel between the data processing system 2000 and the remote data processing system 4000 via the communications network 3600. Accordingly, the invention is well-suited for developing as broadband services become more widely available to provide more elaborate presentations as image data, moving image data, a multimedia format, a streaming video format, or audiovisual presentation to further gain the interest of customers.

The viewer file 6000 may include a provision for communicating over email or otherwise communicating over the communications network 3600 to enter an order based upon the displayed electronically definable catalog at the customer terminal 4000. Such an order may be completed by a telephone call, a fax, or may be completed automatically via entries and data messages sent over the communications network 3600. The customer terminal 4000 may be provided with an interface for selecting item numbers, item identifiers, quantities indicating form of payment and shipment address, and other pertinent information for ordering such goods and products displayed in the viewer file 60. At the point of a customer order, the user can touch the order button and be presented with a form whereby the customer can enter his/her name, address, phone number and credit card information. Upon entry of credit card information, the credit card's numbers can be encrypted. This encryption feature can eliminate the need for a secure server as the information on the credit card is not available to the Internet until after the order entry process is complete. Once the order is completed it can be attached to an email and returned to the issuing body for decryption and processing.

Besides supporting the sales side of a transaction, the embodiments of the method and system of the present invention can support an inventory sharing scheme between stores, suppliers or trading partners. Trading partners may represent a network of distributors that distribute common goods or even non-overlapping goods. Rather than maintaining a large inventory, multiple trading partners may share information about their existing inventory of goods or products to reduce the expenses of storing the inventory in warehouses or having unsold inventory on their books. Although the inventory sharing is facilitated through an exchange of an inventory-sharing file, the exchange may be modified to share an electronically definable catalog or another data format, consistent with the principles of the invention, while falling within the scope of the invention.

In embodiments of the electronically definable catalog, sorting functionality can also be included which allows the entries of the electronically definable catalog to be sorted according to any number of criteria including cost or type of jewelry product.

Another exemplary embodiment of a method of creating a type of an electronically definable catalog, i.e. an HTML electronically definable catalog, is as follows. As used herein, the term “HTML electronically definable catalog” means an electronically definable catalog which can be accessed by a viewer from the internet or through a shortcut placed in an email. The executable version of the electronically definable catalog, described with reference to FIG. 13, can be included in the HTML version allowing a user to save the electronically definable catalog via download from the HTML version. A VI operator can retrieve jewelry product data from a database which is accessible to VI. The VI operator can then build an item record in VI for each piece of jewelry product data that was retrieved. As used herein, the term “item record” means a group of one or more fields describing a jewelry product. For example, an item record could include fields for information, including, but not limited to, jewelry product data and an image of the jewelry product. The jewelry product data could be stored in a binary format. The image of the jewelry product could be stored in any format enabling an image to be stored and later viewed. Next, the VI operator can build a viewer file, which would primarily serve as an extractor of the information in the fields of the item record. The VI operator can then append a header record to the viewer file. As used herein, the term “header record” means a record which contains fields to contain various pieces of information including, but not limited to, the number of item records built and the size of the viewer file. The VI operator can then populate the fields of the header record with the relevant information, including, but not limited to, the number of item records built and the size of the viewer file.

The VI operator can write and save the viewer file and the appended header record together as an executable file. The header record of the executable file can be read to determine the size of the viewer file. The size of the viewer file can be used as an offset to indicate the beginning location of the item records.

The viewer file can then be used to extract the data in the fields of the item record by extracting jewelry product data into data arrays, and by extracting images of the jewelry product data into a temporary folder.

The VI operator can build a shortcut which connects a user of the shortcut to the data arrays containing the jewelry product data. The VI operator can also build a shortcut which connects a user of the shortcut to the temporary folder containing the images of the jewelry product data. As used herein, the term “shortcut” means a computer file that points to another computer file or computer folder. Clicking on an icon that represents the shortcut will take a user to the computer file or computer folder to which the shortcut points. The shortcut can be saved as a Uniform Resource Locator (“URL”) computer file which can be found on the internet.

The HTML embodiment of the electronically definable catalog can be created in a directory on a personal computer or other storage location and then uploaded to an FTP site on the Internet.

A user of the shortcut can build the HTML electronically definable catalog by accessing the data arrays and the temporary folder by clicking on the shortcut. The user can create the electronically definable catalog by compiling, in VI software, jewelry product data and extracting images of the jewelry product data.

After the HTML electronically definable catalog is created, the VI operator can optionally destroy the temporary files in which the images of the jewelry products were stored.

The foregoing description of the method and system of distributing an electronically definable catalog and sharing inventory described several illustrative examples of the invention. Modifications, alternative arrangements, and variations of these illustrative examples are possible and may fall within the scope of the invention. Accordingly, the following claims should be accorded the reasonably broadest interpretation which is consistent with the specification disclosed herein and not unduly limited by aspects of the preferred embodiments disclosed herein.

Referring to FIGS. 2 and 2a, in step 215, an insurance application is completed at the point of sale. Completion of the insurance application comprises completing various inquiries on the insurance application including, but not limited to, customer contact information, insurance policy premium payment information, and authorization for insurance. The insurance policy premium payment information can include information for a credit card payment of the premium for the year, and authorization to charge the credit card. The completion of the insurance application can be performed in any number of ways, including, but not limited to, inputting data into fields of an online insurance application by typing on a keyboard that is connected to the POS-C 15 or printing the insurance application from a printer that can be accessed by the POS-C 15 and having the customer or other person at the point of sale 10 complete the insurance application by writing, typing or otherwise placing information in the various fields of the insurance application.

In step 220 of FIGS. 2 and 2a, the appraisal and the insurance application are submitted to an II 35 from the POS 10. The appraisal and the insurance application can be transmitted to the II 35 by any number of methods, including, but not limited to, email, internet website, fax or United States Postal Service mail as explained in the foregoing description of FIG. 1.

Referring to FIG. 2a, in step 226, the POS 10, in response to obtaining and printing the appraisal from the appraiser located at the central location and previously stored at the POS 10 in step 209, the POS 10 the location of the II 35, compensates the appraiser 11 upon printing the appraisal at the point of sale 10. The compensation can take place at any time after the appraisal is printed at the point of sale 10. Upon receiving compensation from the POS 10 in step 228, the appraiser 11 can compensate the software vendor 38 if the appraiser used software from the vendor to transmit the appraisal.

The capability for an appraiser to generate a single appraisal for a group of similar jewelry products e.g. a group of rings that have similar mounting and near identical components, and send that appraisal over a network using Virtual Inventory's exchange method to provide the appraisal data to all databases within the network so that any POS selling the jewelry product can produce an immediate appraisal in response to a customer can be invaluable. Alternately, the appraiser can appraise a single jewelry product that is unique and distribute it within a network of stores where but the jewelry product is sold in, for example, a retail outlet in a company network of stores. Using Virtual Inventory's ability to share the appraisal with any POS in a network enables the ability to the POS to have an appraisal available regardless of where the jewelry article is sold. This method creates an economy of scale that allows the appraiser to provide an appraisal at a reduced cost making the appraisal and ultimately the insurance more affordable.

Referring to FIGS. 2 and 2a, in step 230, the II 35, in response to receiving the appraisal and the insurance application, selects an IP 45 and submits the appraisal and the insurance application to the IP 45. The selection of the IP 45 can be dictated by any number of methods or criteria as deemed appropriate by the II 35. For example, geographical location of the IP 45 and/or the premium cost and/or coverage limits and policy deductibles might be criteria that the II 35 uses to choose among one or more IP 45. The appraisal and the insurance application can be transmitted to the IP 45 by any number of methods, including, but not limited to, email, internet website, fax or United States Postal Service mail as explained in the foregoing description of FIG. 1.

The foregoing methods 200 and 200a and orders described in FIGS. 2 and 2a are merely exemplary of embodiments of the present invention and steps in other embodiments of the present invention may be arranged in different orders and be aligned with the spirit of providing a method of applying for jewelry insurance at a point of sale.

In response to the IP 45 receiving the appraisal and the insurance application, the customer can be given conditional coverage by the IP 45. Notice of conditional coverage is not required. Binding authority can be given by the IP 45 at the time of receipt of the completed insurance application and the appraisal. Conditional coverage can begin immediately upon receipt of the appraisal and the insurance application if the appraisal and the insurance application were transmitted by electronic methods such as email, uploading or downloading to or from the website belonging to the IP 45 or fax. Conditional coverage can be retroactively granted, upon receipt of the appraisal and the insurance application, to the postmarked date on the envelope containing the appraisal and the insurance application if the appraisal and the insurance application were transmitted to the IP 45 by mail.

In response to the IP 45 receiving the appraisal and the insurance application and approving the insurance application, the IP 45 can compensate the II 35 with a commission for the insurance referral. Compensation can take place by any number of methods. Additionally, the compensation can take place at any length of time after the IP 45 receives the appraisal and the insurance application and approves the insurance application and need not occur immediately upon receipt of the appraisal and the insurance application and approval of the insurance application.

The IP can review the appraisal and the insurance application and, upon approving the insurance application, can issue a policy to the customer indicating the customer's insurance coverage for the jewelry product. Notice of coverage is not required. Binding authority has been given by the IP 45 at the time of receipt of the application and the appraisal.

If the IP 45 does not approve the insurance application, a notice of cancellation of the conditional coverage that was granted upon receipt of the appraisal and the insurance application can be sent either to the POS 10 or to the customer with a pro rata refund of the payment that the customer made in the amount of the conditional coverage that was given. Notice of cancellation of the conditional coverage to the PO 10 or the customer and compensation to the II 35 can be transmitted by any number of the foregoing methods described in the foregoing paragraphs.

If the IP 45 approved the insurance application, at renewal time, should the customer desire to renew insurance coverage for the jewelry product that was insured through the point of sale jewelry application process, the appraiser can provide a current appraisal to the II 35 or to the POS 10. If the appraiser provides the current appraisal to the POS 10, the POS 10 can then provide the current appraisal to the II 35. The updated appraisal can be provided by the appraiser to the II 35 and, when required, to the IP 45. The appraiser giving the updated appraisal can then earn a fee paid by the II 35.

The current appraisal can be provided in the form of a text file showing the entire set of appraisals that have been updated, the text file containing a list of all appraisals that the point of sale has issued. The II 35 can check the contents of the text file against a similar text file that the II 35 has access to that includes all active insurance policies provided by the IP 45. This process wherein the POS 10 sends a text file and the II 35 comparing to a text file of all active insurance policies provide by the IP 45 is sufficient for receiving an updated appraisal until such time as the IP 45 requires that the jewelry product be submitted for examination to renew the policy. An automated updating procedure within the VI software can keep the appraisal current.

In response to receiving the current appraisal, or alternately, a text file indicating that the appraisal has been updated, the II 35 can compensate the appraiser (which can be an independent appraiser or the POS 10 representative) with an annual fee corresponding to the annually updated current appraisal that is used for underwriting the insurance policy. If an appraiser located at a location other than the point of sale 10 produces the updated appraisal, gives it to the point of sale representative and the point of sale representative furnishes it to the II, the II 35 can compensate the appraiser for producing the appraisal for the point of sale representative and the II 35 can compensate the software company that an appraiser may use to communicate the updated appraisal to the point of sale representative.

The II 35 can request, from the IP 45, renewal of insurance for the jewelry product. The appraisal used to underwrite the policy has value to the underwriter and therefore the appraiser is paid a fee to maintain the appraisals market valuation annually. The appraiser can be the point of sale 10 or an independent appraiser. The use of a software program that maintains a database of appraisals can be used to update the values of the appraisals contained in the database, over a given period of time, in an application designed to group like components and raise or lower values according to the current market conditions.

In certain embodiments, an individual appraisal and/or database or other grouping of appraisals may be created and/or updated in any geographical region to provide a current Retail Market Value for replacing individual items of jewelry at retail replacement costs. For example, a computer generated software program may be used to provide a template for appraising articles of jewelry. The appraisals may be written taking into account certain components that make up the wholesale value of the article of jewelry being evaluated in the appraisal. The retail market value of the jewelry being appraised is an additional pricing component set by the appraiser.

When an appraiser begins the process of writing the appraisal, the appraiser typically analyzes certain specific components of the jewelry article and evaluates one or more qualities of these components. As the grading of the article is determined, the software assigns a monetary value to each component. The software is enabled with data that is available either online or in printed publications that determine wholesale values. This information may be entered into the software's database in an automated fashion showing the average wholesale cost for diamonds and gemstones. The program is also capable of entering the current values of precious metals using standard and/or custom formulas to determine the approximate cost of the mountings into which diamonds and gemstones are set, for example. The program may also allow for a cost for labor and additional values for designer jewelry, for example.

When creating the initial appraisal, the appraiser enters the costs of the components of the article of jewelry in the software program and then adds the current retail market value of the jewelry product. This markup is a formula that is some multiple of the cost of the wholesale value of the jewelry article, for example. Different geographical areas sell the same jewelry article for varying monetary considerations, for example.

The value of the appraisal software is that it calculates the wholesale prices of an article as a percentage of the overall markup. When updates are to be generated for the appraisal, new wholesale costs are entered into the database of jewelry appraisals. The new wholesale price changes the cost structure of the jewelry; the formula for the markup is calculated automatically and pricing for the market is rendered for that article of jewelry. The method for the markup is the percentage that the wholesale value is of the total markup for the appraised valuation. For example, a jewelry article is appraised for $12000. The wholesale cost of this piece is $8000. The wholesale cost of $8000 divided into the appraisal of $12000 equals 1.5%. If the wholesale value increases to $8400, the automatic markup to retail would increase by 1.5% for a value of $12,600, for example.

Using this wholesale pricing structure methodology, along with the calculations based on the market the appraiser is advising upon, this program may update a database of appraisals in aggregate. The amount of time spent updating each individual appraisal is reduced. By using the search engine in the software to isolate different pieces of jewelry to account for anomalies in the market, a user may adjust retail values accordingly.

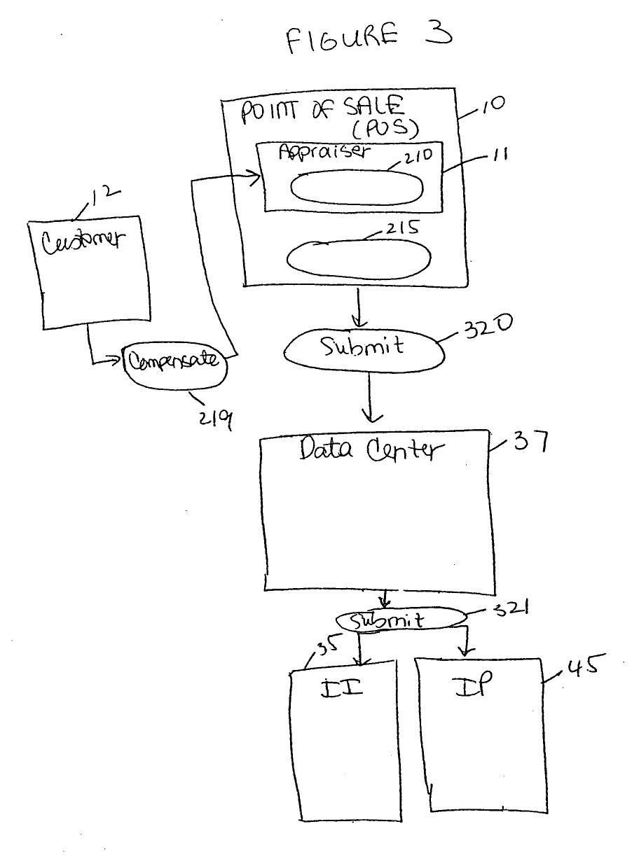

FIG. 3 is an exemplary schematic flowchart illustrating a method 300 for applying for insurance for a jewelry product at a point of sale according to an embodiment of the present invention. In the method, a customer has purchased jewelry at a point of sale 10 and has decided to begin the process to apply for insurance on the jewelry product that has been purchased.

Referring to FIG. 3, in step 210, an appraisal is obtained at the point of sale 10, and in step 219, the customer 12 compensates the point of sale for the appraisal. The appraiser may be the POS 10 representative or an independent appraiser. The appraisal value can be determined through any process leading to the assignment of an appraisal value to a jewelry product, including, but not limited to, using software which merges an appraisal value that has been pre-stored in a database with information on the corresponding jewelry product that has also been pre-stored in the database; or causing an appraiser 11 to evaluate a jewelry product and assigning the jewelry product an appraisal value at the time that the jewelry product is purchased. Alternately, an appraisal value can be determined for a jewelry product purchased at some other point of sale by causing an appraiser 11 located at a point of sale to evaluate the jewelry product and assign the jewelry product an appraisal value at the time that the customer presents the jewelry product to the appraiser 11.

The appraisal documentation can be generated, and therefore the appraisal can be obtained, through any number of means that produces a document that communicates the contents of the identity and the appraisal value of a jewelry product to the II 35 and/or the IP 45, including, but not limited to, software which can generate a formatted appraisal, a document produced by hand, typed or generated by any word processing system. Further, the appraisal document can be in paper or electronic format.

One exemplary software product which can be used to generate appraisal documents is the Virtual Inventory Point of Sale module (“VI POS module”) which is one of a suite of Virtual Inventory (“VI”) software modules. The VI POS module can generate an appraisal for jewelry that is either located within a VI database that is accessible by the VI POS module or that is not located within the VI database that is accessible by the VI POS module.

The VI POS module can generate an appraisal for jewelry that is located within a VI database that is accessible by the VI POS module by merging previously stored jewelry product appraisal information with customer contact information.

For example, FIG. 2b is an exemplary illustration depicting a VI POS user interface for generating an appraisal document at a point of sale when the jewelry product is in a VI database that is accessible by the VI POS module. At the startup of the VI system, a VI operator can depress an Appraisal button and then depress an Add New Appraisal button to arrive at the Add New Appraisal page which contains the user interface shown in FIG. 2b. The Add New Appraisal page contains a Customer Info tab 211, an Inventory Item Info tab 212, and an Appraisal tab 213.

Selecting the Customer Info tab 211 displays a page containing a user interface with fields that the VI operator can populate with information pertaining to the customer receiving the appraisal. As used herein, the term “fields” means text input boxes which a VI operator can populate through the use of methods including, but not limited to, selection of text from pull-down menus or typing in text manually. Selecting the Inventory Item Info tab 212 displays a page containing a user interface with fields in which the VI operator can input or select, via a pull-down menu, text describing the identity of the jewelry product for which an appraisal is being generated. Selecting the Appraisal tab 213 displays a page containing a user interface with fields in which the VI operator can select, via a pull-down menu, appraisal information. The VI operator can use a pull-down menu to retrieve an appraisal value and other information that has been pre-stored in the VI database thereby allowing the appraisal information to be automatically entered into the appraisal field. This information can be overwritten by a VI operator. For instance, the information that automatically enters the appraisal field can be edited. However, if the information is edited, VI can have the capability to prevent a digital signature belonging to the appraiser that formulated the initial appraisal value from being placed on the appraisal and the appraisal can be printed and signed by the person editing the appraisal.

The foregoing method described with reference to FIG. 2b is merely exemplary and the VI operator can select the tabs, and populate the fields on each page that correspond to each tab, in any order. Additionally, various fields can optionally be left in an unpopulated state and an appraisal can still be generated.

Referring to FIG. 2b, in order to generate the appraisal, the VI operator can select the Customer Info tab 211 and populate the fields with information pertaining to the customer. If the customer is already in the VI database, the customer information can be retrieved by selecting the customer's name from a pull-down menu associated with the input location for the customer's name. The other fields for which information about the customer is stored in the VI database will be automatically populated as a result of selecting the customer's name from the pull-down menu. If the customer is not already in the VI database, the VI operator can depress the New button 218 and enter the customer's information. The VI operator can then select the Inventory Item Info tab 212 and enter information about the identity of the jewelry product being appraised or use a pull-down menu and select information about the identity of the jewelry product being appraised. The VI operator can then select the Appraisal tab 213 and enter appraisal information for the jewelry product. If an appraiser has already appraised the jewelry product and the appraisal information has been stored in the database, the VI operator can use a pull-down menu to retrieve the appraisal information. If appraisal information is not already stored in the database, an appraiser can evaluate the jewelry product and populate the fields with information such as the appraisal value. To generate the appraisal, the VI operator can then depress the Print Item Appraisal button 214 or depress the Save New Appraisal button 216 to generate the appraisal in paper or electronic formats, respectively. The VI operator can abandon the appraisal by depressing the Abandon New Appraisal 217 button.

The VI POS module can also generate an appraisal for jewelry that is not within a VI database by having an appraiser evaluate and input the appraised value and related information into the VI POS module, capture an image of the jewelry with a device such as a camera or any other device capable of capturing an image, and merge the jewelry information with the customer contact information in an appraisal document.

The appraisal generated by the VI POS module can include various pieces of information, including, but not limited to, the type of jewelry product being appraised; the type and weight of the stone within the jewelry product; replacement cost of the jewelry product; a short paragraph or a book length description describing the jewelry product; and a designated location for the appraiser 11 to sign and date the appraisal document.

The VI software can also include functionality enabling it to perform a host of other varied operations including, but not limited to, functionality which allows the operator to maintain customer personal and purchase-history information; print product sales tags; maintain and track repair and jewelry-adjustment jobs, maintain a pictorial inventory of jewelry, track and search inventory and record sales; generate, deliver and/or print customized electronically definable catalogs; encrypt jewelry price information, sales and vendor analysis; facilitate inventory exchange with other VI software owners; send emails that contain particular company brand information; perform data compression, website administration or inventory tagging; encrypted inventory tagging for image identification of inventory items, search the VI database and/or customized electronically definable catalogs; operate VI over multiple databases; import or export of data; perform system security for different classes of users; and perform pictorial job bagging and file containment. Steps to operate the VI software to perform these and other functions are described in the Virtual Inventory Manual.

One exemplary function of the VI software is the ability to create customized electronically definable catalogs. The electronically definable catalogs can include functionality which allows for: personalized messaging; direct transmissions to and from a website; presentation of jewelry products and associated information; searching catalogue; printing catalogue; making multi-media presentations; online or offline displaying and/or viewing of jewelry product images and/or text; displaying jewelry product images and text simultaneously on the same page; creating thumbnail representations of jewelry product images; creating customized catalogs for specific customers or customer prospects based on data mining; enabling two or more VI operators to send, receive and share data allowing items transmitted from a sending user to be automatically incorporated into the database of a receiving user.

An electronically definable catalog generally comprises a group or ordered series of catalog entries. For example, the catalog entries may include a first catalog entry, any intermediary catalog entries (a second catalog entry), and an Nth catalog entry, where N refers to the maximum number of catalog entries. The maximum number of catalog entries may be commensurate with a maximum viewer file size that may be stored on a particular storage medium, a maximum viewer file size that may be transmitted over the communications network to a customer terminal within a maximum time interval (e.g., five minutes), or both. The maximum viewer file size may be proportional to the transmission capacity of the communications network (e.g., the Internet) or a portion thereof.

The following describes only one of the many possible embodiments of an electronically definable catalog. An electronically definable catalog can be designed such that each catalog entry includes jewelry product image data or textual data on a jewelry product that is for sale as well as format data. The user interface may support the entry of the jewelry product image data in the form of an image file inputted into the database management system for storage in the first database. For example, the jewelry product image file may be stored as a TIFF, an MPEG file, a JPEG file, or another suitable data format. Similarly, the user interface may support the entry of the textual data on a jewelry product that is for sale. For example, the user interface may support the entry of textual data on the jewelry product that is for sale or a textual file for one or more jewelry products for sale. The user interface supports entry or manipulation of the format data or other organizational data.

A user interface is coupled to the data processing system for entering a user preference, selection, or other user input related to the formation and distribution of the electronically definable catalog. The data processing system comprises a selector that communicates with an editor. In turn, the editor may communicate with a communications interface, a data management interface, or both.

The storage device may store marketing data or demographic data, or customer specific data in a marketing database or a third database. The selector can select a group of catalog entries from the first database based on marketing data for at least one targeted customer.

The editor supports organization of a group of catalog entries to form an electronically definable catalog. The electronically definable catalog can contain entries that are targeted toward a certain customer group or targeted customer audience found in the first database or found in a general catalog. The first database may represent all of the jewelry products which may be offered for sale by a certain store, seller, or supplier.

Each catalog entry may include a visual component and a textual component. The visual component generally comprises an image of the jewelry product offered for sale. For example the visual component may comprise a JPEG file, a TIFF image file, an MPEG file, or another file for storing and representing the image such as GIF and Animated GIF. JPEG (Joint Photographic Experts Group) refers to a standard data compression technique for compressing an image file. MPEG (Moving Picture Experts Group) refers to a standard data compression technique for storing a digital video file. TIFF (tagged image file format) refers to a format for storing bit-mapped images, which may represent color or black and white images. Virtually any file format can be presented within the catalog.

The editor can include a presentation module for manipulating the presentation or appearance of the electronically definable catalog in a desired manner in conformance with user input entered on one or more user interfaces. Similarly, the augmentation module can support a user's augmentation or addition of supplemental data to catalog entries retrieved from the first database. The addition of supplemental data can support flexibility and customization of the electronically definable catalog. In one example, the user interface supports entry of supplemental data or augmentation data from a user interface to supplement or vary the entries of an electronically definable catalog from the entries available in the first database. In another example, the user interface supports selection of supplemental data or augmentation data from a database (e.g., a marketing database) in the storage device.

In embodiments of the electronically definable catalog, sorting functionality can also be included which allows the entries of the electronically definable catalog to be sorted according to any number of criteria including cost or type of jewelry product. The electronically definable catalog can be distributed by electronic transmission over communication lines which can be wired or wireless or the electronically definable catalog can be stored on media capable of holding data including, but not limited to, a compact disk, a DVD, a floppy disk, an optical disk, tape, or any other storage medium that may be readily mailed or delivered to targeted customers.

The electronically definable catalog can be viewed using the viewer file. The viewer file can be comprised of various pieces of data including, but not limited to, encryption data an executable file with corresponding executable instructions. The term “executable instructions” means instructions for displaying or interacting with the electronically definable catalog at a customer terminal. The encryption data may scramble, encode, or encrypt both the electronically definable catalog data and the executable instructions. The encryption data may be thought of as a shell that encapsulates both the electronically definable catalog data and the executable data. The encryption shell must be removed by the customer terminal by the entry of a proper code, password, login identifier, or other verification scheme.

The viewer file is generally a self-executing file that does not require additional software programs other than an operating system to support it. Further the executable instructions may be configured to be compatible with multiple operating systems or multiple versions of the executable instructions may be included in each of the viewer files to support multiple platforms to attain the widest possible dissemination of the electronically definable catalog.

An exemplary embodiment of a method of creating an HTML electronically definable catalog is as follows. As used herein, the term “HTML electronically definable catalog” means an electronically definable catalog which can be accessed by a viewer from the internet or through a shortcut placed in an email. A VI operator can retrieve jewelry product data from a database which is accessible to VI. The VI operator can then build an item record in VI for each piece of jewelry product data that was retrieved. As used herein, the term “item record” means a group of one or more fields describing a jewelry product. For example, an item record could include fields for information, including, but not limited to, jewelry product data and an image of the jewelry product. The jewelry product data could be stored in a binary format. The image of the jewelry product could be stored in any format enabling an image to be stored and later viewed. Next, the VI operator can build a viewer file, which would primarily serve as an extractor of the information in the fields of the item record. The VI operator can then append a header record to the viewer file. As used herein, the term “header record” means a record which contains fields to contain various pieces of information including, but not limited to, the number of item records built and the size of the viewer file. The VI operator can then populate the fields of the header record with the relevant information, including, but not limited to, the number of item records built and the size of the viewer file.

The VI operator can write and save the viewer file and the appended header record together as an executable file. The header record of the executable file can be read to determine the size of the viewer file. The size of the viewer file can be used as an offset to indicate the beginning location of the item records.

The viewer file can then be used to extract the data in the fields of the item record by extracting jewelry product data into data arrays, and by extracting images of the jewelry product data into a temporary folder.

The VI operator can build a shortcut which connects a user of the shortcut to the data arrays containing the jewelry product data. The VI operator can also build a shortcut which connects a user of the shortcut to the temporary folder containing the images of the jewelry product data. As used herein, the term “shortcut” means a computer file that points to another computer file or computer folder. Clicking on an icon that represents the shortcut will take a user to the computer file or computer folder to which the shortcut points. The shortcut can be saved as a Uniform Resource Locator (“URL”) computer file which can be found on the internet.

A user of the shortcut can build the HTML electronically definable catalog by accessing the data arrays and the temporary folder by clicking on the shortcut. The user can create the electronically definable catalog by compiling, in VI software, jewelry product data and extracting images of the jewelry product data.

After the HTML electronically definable catalog is created, the VI operator can optionally destroy the temporary files in which the images of the jewelry products were stored.

Referring to FIG. 3, in step 215, an insurance application is completed at the point of sale. Completion of the insurance application comprises completing various inquiries on the insurance application including, but not limited to, customer contact information, payment information, and authorization for insurance. The payment information may include, but need not be limited to, the administrative fee payment information and insurance premium payment information. The completion of the insurance application can be performed in any number of ways, including, but not limited to, inputting data into fields of an online insurance application by typing on a keyboard that is connected to the POS-C 15 or printing the insurance application from a printer that can be accessed by the POS-C 15 and having the customer or other person at the point of sale 10 complete the insurance application by writing, typing or otherwise placing information in the various fields of the insurance application.

In step 320, the appraisal and the insurance application are submitted to either a central location that can receive data and simultaneously transmit the data to multiple locations, such as a Data Center 37, as shown in FIG. 3, or submitted separately to both the II 35 and an IP 45 simultaneously (not shown). If the appraisal and insurance application are submitted to a Data Center 37, as shown in FIG. 3, the Data Center 37 then submits the appraisal and the insurance application to both the II 35 and the IP 45. The identity of the IP 45 can be known to a representative at the POS 10 as the II 35 can give the representative at the POS 10 the identity of the IP 45 at some time prior to the time when the customer applies for insurance at the POS 10.

The appraisal and the insurance application can be transmitted to the II 35 and the IP 45 or to the Data Center 37 by any number of methods, including, but not limited to, email, internet website, fax, United States Postal Service mail, as explained in the foregoing description of FIG. 1.

The IP 45, in response to receiving the appraisal and the insurance application and approving policy, may submit compensation for the insurance referral to the II 35. The compensation can be submitted to the II 35 by any number of methods, including, but not limited to, email, internet website, fax or United States Postal Service mail as explained in the foregoing description of FIG. 1.

The foregoing method 300 and order described in FIG. 3 is merely exemplary of one embodiment of the present invention and steps in other embodiments of the present invention may be arranged in different orders and be aligned with the spirit of providing a method of applying for jewelry insurance at a point of sale whereby the appraisal and the insurance application are submitted, from the point of sale directly to the IP 45.

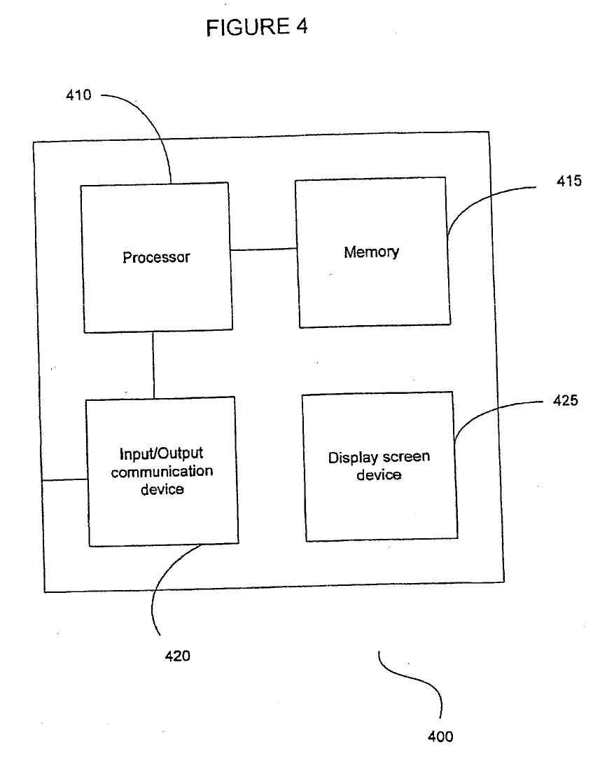

FIG. 4 is an exemplary illustration of a device that can perform a method for applying for insurance for a jewelry product at a point of sale according to an embodiment of the present invention. The processor 410 can access the memory 415 and receive inputs and transmit outputs via an input/output communication device 420 that can receive inputs from devices, including, but not limited to, a keyboard, a scanner or an external fax machine, and can display the insurance application and any appraisal that is generated on a display screen which is controlled by the display screen device 425. The processor 410 can contain instructions for performing various functions, including, but not limited to, generating an insurance application to be completed at the point of sale; receiving input for populating fields of an online insurance application, generating and receiving an appraisal, sending or receiving information transmitted via any number of methods, including, but not limited to, email or fax or uploading or downloading to or from an internet website or printing documents. The processor 410 can also generate, at renewal time, a current appraisal and provide the current appraisal to an II. Additionally, the processor can contain instructions for controlling printers, external fax machines and other electronic and mechanical devices which are routinely controlled by computers.

The memory 415 can be comprised of temporary (e.g., random access memory (RAM), flash or permanent memory (e.g., read only memory (ROM)). ROM can be used to store the formatting information for generating an appraisal or for generating an insurance application that is completed at the point of sale.

Another possible embodiment of the present invention is as a computer program product. A computer program product comprises a computer readable storage medium and computer readable language. The computer readable storage medium is the location in which the computer program product is captured. Exemplary computer readable storage media can include, but are not limited to, ROM and paper on which the computer program product can be written and then transferred to and run on a processor of the type, including, but not limited to, that found in 410.

The computer readable language is the set of instructions that dictates the operations that the processor takes according to the present invention. The computer readable language may include, but is not limited to, high-level language such as C, C++, Dot net or other machine or assembly languages.

The computer readable language can be executed to cause a processor to perform functions for generating an insurance application to be completed at the point of sale; receiving input for populating fields of an online insurance application, generating and receiving an appraisal, sending or receiving information transmitted via any number of methods, including, but not limited to, email or fax or uploading or downloading to or from an internet website or printing documents. The computer readable language can also be executed to cause a processor to perform functions for generating, at renewal time, a current appraisal and provide the current appraisal to an II. Additionally, the computer readable language can be executed to cause a processor to perform functions for controlling printers, external fax machines and other electronic and mechanical devices which are routinely controlled by computers.

It should be noted that although the flow charts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments, and description with regard to jewelry products, were chosen and described in order to explain the principals of the invention and its practical application to enable one skilled in the art to utilize the invention in various embodiments, as applied to various other items for which insurance can be applied for at a point of sale such as fine art products, antiques, collectables, coins and furs; any product that might have an insurable value, and with various modifications as are suited to the particular item and/or use contemplated.

What is claimed is:

1. A method for applying for jewelry insurance for a jewelry product at a point of sale, the method comprising:
generating an appraisal for a jewelry product at a point of sale;
receiving compensation at the point of sale in response to receiving the appraisal for the jewelry product at a point of sale;
completing an insurance application at the point of sale;
submitting, from the point of sale, the appraisal, the insurance application to an insurance intermediary;
selecting an insurance provider via an insurance intermediary, in response to receiving the appraisal and the insurance application; and
submitting the appraisal and the insurance application to the insurance provider.

2. The method of claim 1, further comprising the insurance provider, in response to receiving the appraisal and the insurance application and approving the insurance application, compensating the insurance intermediary.

3. The method of claim 1, wherein completing the insurance application at the point of sale comprises a customer providing payment information and authorization for insurance.

4. The method of claim 1, further comprising:
at renewal time, the appraiser providing a current appraisal to the point of sale;
the point of sale, in response to receiving the current appraisal, providing the current appraisal to the insurance intermediary; and
the insurance intermediary, in response to receiving the current appraisal, compensating the appraiser for the current appraisal.

5. The method of claim 1, further comprising:
at renewal time, the appraiser providing a current appraisal to the insurance intermediary; and
the insurance intermediary, in response to receiving the current appraisal, compensating the appraiser for the current appraisal.

6. The method of claim 4, further comprising the insurance intermediary submitting a current appraisal to the insurance provider and requesting renewal of insurance for the product.

7. The method of claim 5, further comprising the insurance intermediary submitting a current appraisal to the insurance provider and requesting renewal of insurance for the product.

8. A method for applying for jewelry insurance for a jewelry product at a point of sale, the method comprising:
obtaining an appraisal for a product at a point of sale;
compensating the point of sale in response to receiving the appraisal for the product at a point of sale;
completing an insurance application at the point of sale;
submitting, from the point of sale, the appraisal and the insurance application to an insurance intermediary and an insurance provider selected by the insurance intermediary; and
submitting administrative fee payment information to the insurance intermediary from the insurance provider in response to receiving the appraisal and the insurance application.

9. The method of claim 8, further comprising the insurance provider, in response to receiving the appraisal and the insurance application and approving the insurance application, compensating the insurance intermediary.

10. The method of claim 8, wherein completing the insurance application at the point of sale comprises a customer providing payment information and authorization for insurance.

11. The method of claim 8, further comprising:
at renewal time, the appraiser providing a current appraisal to the point of sale;
the point of sale, in response to receiving the current appraisal, providing the current appraisal to the insurance intermediary; and
the insurance intermediary, in response to receiving the current appraisal, compensating the appraiser for the current appraisal.

12. The method of claim 8, further comprising:
at renewal time, the appraiser providing a current appraisal to the insurance intermediary; and
the insurance intermediary, in response to receiving the current appraisal, compensating the appraiser for the current appraisal.

13. The method of claim 11, further comprising the insurance intermediary submitting the current appraisal to the insurance provider and requesting renewal of insurance for the product.

14. The method of claim 12, further comprising the insurance intermediary submitting the current appraisal to the insurance provider and requesting renewal of insurance for the product.

15. A system for obtaining insurance for a fine art or jewelry product, said system comprising:
a point of sale computer configured to enable appraisal of a product and generation of an insurance application for the product, said point of sale computer configured to transmit the appraisal and the insurance application; and
an insurance computer configured to receive the appraisal and insurance application and generate an insurance policy covering the product.

16. The system of claim 15, wherein said point of sale computer enables updating of the appraisal of the product.

17. The system of claim 16, wherein an updated appraisal for the product is based on updated wholesale price information for the product and a markup percentage with respect to the original wholesale price and retail price for the product.

18. The system of claim 15, wherein said point of sale computer is configured to dynamically generate an electronic catalog including one or more products selected from an inventory database based on marketing data for at least one targeted customer.

19. The system of claim 15, wherein said insurance computer comprises an insurance intermediary computer and an insurance provider computer.

20. At least one computer readable medium including a set of instructions for execution on a computer, said set of instructions comprising:
an appraisal routine for generating an appraisal of at least one of a jewelry product and an art product based on product information;
an insurance application routine for generating an application for an insurance policy covering the at least one of a jewelry product and an art product, wherein said appraisal and said application are completed at a point of sale for a customer purchasing the at least one of a jewelry product and an art product; and
an insurance approval routine for approving insurance coverage of the at least one of a jewelry product and an art product and for generating an insurance policy covering the at least one of a jewelry product and an art product, wherein the customer receives the insurance policy at the point of sale.

21. The set of instructions of claim 20, further comprising a catalog generation routine for dynamically generating an electronic catalog of at least one of jewelry products and art products from a database based on marketing data for at least one targeted customer.
